(19) United States
(12) Patent Application Publication
(10) Pub. No.: US 2025/0160272 A1
(43) Pub. Date: May 22, 2025

(54) SELF-WATERING PLANTER KITS

(71) Applicant: Jack Barnwell, Naples, FL (US)

(72) Inventor: Jack Barnwell, Naples, FL (US)

(21) Appl. No.: 18/842,452

(22) PCT Filed: Mar. 1, 2023
(86) PCT No.: PCT/US2023/014228

§ 371 Date: Aug. 29, 2024

Related U.S. Application Data
(60) Provisional application No. 63/315,720, filed on Mar. 2, 2022.

(51) Int. Cl. A01G 27/02; A01G 9/02; A01G 27/00

(52) U.S. Cl. CPC A01G 27/02; A01G 9/02; A01G 27/005

(57) ABSTRACT

A self-watering planter kits, assembled self-watering planter kits, and associated methods, are described. A self-watering planter kit may include a reservoir configured to be disposed in a container, a platform configured to be disposed over the reservoir, and a fill tube configured to be disposed through the platform.

### RELATED APPLICATIONS

This application claims priority to U.S. Provisional Application No. 63/315,720, filed under 35 U.S.C. § 111(b) on Mar. 2, 2022. The entire disclosure of the aforementioned application is expressly incorporated hereby by reference for all purposes.

### BACKGROUND

Current self-watering planters are prone to problems or otherwise have disadvantages such as poor root growth from improper watering, inefficient water and nutrient delivery, toxic mineral buildup, fungi, and the use of cheap plastics. Thus, there is a need for new and improved self-watering planters and kits.

### SUMMARY

Provided herein is a self-watering planter comprising a container comprising a bottom wall and at least one side wall which defines a cavity in the container, wherein the at least one side wall includes a hole therethrough; a platform having a first surface and a second surface and an outer wall, wherein the platform is adapted to fit in the cavity and thereby separate the cavity into a first environment and a second environment, wherein the platform has an aperture extending through the platform and an opening extending through the platform, and wherein the aperture includes a down tube retaining feature; a down tube having a body spanning a length between a first end and a second end, wherein the first end includes a platform retaining feature configured to mate with the down tube retaining feature, wherein the down tube further comprises at least one slit along the length of the body; and a fill tube having a body extending between a fill tube first end and a fill tube second end, wherein the fill tube is configured to extend through the opening in the platform.

Further provided herein is a self-watering planter comprising a container defining a cavity between an open top and a closed bottom, wherein the container comprises a side wall extending from the open top to the closed bottom; a rim extending around a perimeter of the container in the cavity; a platform configured to rest on the rim in the container, wherein the platform comprises an aperture extending therethrough with a down tube retaining feature, and an opening extending therethrough; a down tube comprising a platform retaining feature configured to mate with the down tube retaining feature of the aperture; and a fill tube configured to extend through the opening. In certain embodiments, the down tube comprises at least one slit therethrough. In certain embodiments, the self-watering planter further comprises a drainage hole in the side wall. In particular embodiments, the drainage hole is positioned between the rim and the closed bottom of the container. In certain embodiments, the container comprises ceramic.

Further provided is a self-watering planter comprising a container defining a cavity between an open top and a closed bottom, wherein the container comprises a side wall extending from the open top to the closed bottom; and a single molded piece defining a platform and a down tube, a single molded piece defining a platform and a down tube, wherein the platform is configured to rest on a rim in the container and the down tube is configured to extend from the platform, wherein the downtube includes at least one slit configured to allow passage of a liquid through the down tube.

Further provided is a self-watering planter comprising a container defining a cavity between an open top and a closed bottom, wherein the container comprises a side wall extending from the open top to the closed bottom; a rim extending around a perimeter of the container in the cavity; a platform configured to rest on the rim in the container and thereby divide the cavity into a first environment and a second environment; and a down tube configured to extend from the aperture to the first environment.

Further provided is a self-watering planter comprising a container defining a cavity between an open top and a closed bottom, wherein the container comprises a side wall extending from the open top to the closed bottom, wherein the side wall includes a hole therethrough; a platform adapted to fit in the cavity and thereby separate the cavity into a first environment and a second environment, wherein the platform has an aperture extending through the platform and having a down tube retaining feature; and a down tube having a body spanning a length between a first end and a second end, wherein the first end includes a platform retaining feature configured to mate with the down tube retaining feature, wherein the down tube further comprises at least one slit along the length of the body configured to allow passage of a liquid therethrough.

Further provided is a self-watering planter comprising a removable platform resting on an annular rim within a container, wherein the platform divides the container into a first environment and a second environment; and a down tube attached to the platform and extending from the platform into the first environment, wherein the downtube includes at least one slit configured to allow passage of a liquid therethrough.

Further provided herein is a self-watering planter comprising a container having a first environment configured to house water and a second environment configured to house soil, wherein liquid can pass from the first environment to the second environment through a down tube having at least one slit therein.

Further provided is a self-watering planter comprising a container having a first environment configured to house water and a second environment configured to house soil, wherein liquid can pass from the first environment to the second environment through a down tube having at least one slit therein.

Further provided is a self-watering planter comprising a container configured to store liquid in a first environment and house a plant planted in soil in a second environment; and a platform and downtube assembly configured to separate the first environment from the second environment and allow passage of the liquid therebetween.

Further provided herein is a method of watering a plant, the method comprising mating a down tube with a platform to form an assembly, wherein the down tube includes at least one slit therethrough; inserting the assembly into a container; adding soil to the assembly; planting a plant in the soil; and watering the plant by housing water in the container so as to travel through the slit.

Further provided is a self-watering planter kit comprising a reservoir having a reservoir bottom wall encircled or enclosed by a reservoir side wall, the reservoir defining a reservoir cavity bounded by the reservoir bottom wall and the reservoir side wall, wherein the reservoir further comprises an outer surface defining a gutter; a platform configured to cover the reservoir cavity, the platform having a platform top surface, a platform bottom surface, a platform aperture extending through the platform, and a platform opening extending through the platform; and a down tube comprising a down tube bottom wall encircled by a down tube side wall and defining a down tube cavity aligned with the platform aperture, wherein the down tube comprises a slit formed through the down tube side wall.

In certain embodiments, the gutter defines a notch that interrupts a top perimeter of the reservoir.

In certain embodiments, the self-watering planter kit further comprises a fill tube configured to be disposed through the platform opening. In particular embodiments, the fill tube comprises a plurality of telescopically connected segments.

In certain embodiments, the self-watering planter kit comprises a plurality of gutters, each of the plurality of gutters defining a notch that interrupts a top perimeter of the reservoir.

In certain embodiments, the down tube comprises a plurality of slits formed through the down tube side wall.

In certain embodiments, the reservoir comprises a foot disposed on an exterior surface of the reservoir bottom wall.

In certain embodiments, the reservoir comprises a plurality of feet disposed on an exterior surface of the reservoir bottom wall.

In certain embodiments, the down tube has a down tube length and the reservoir has a reservoir length, and the down tube length corresponds to the reservoir length.

In certain embodiments, the reservoir side wall is tapered. In certain embodiments, the down tube side wall is tapered.

Further provided is a self-watering planter kit comprising a reservoir having a reservoir bottom wall encircled or enclosed by a reservoir side wall, the reservoir defining a reservoir cavity bounded by the reservoir bottom wall and the reservoir side wall, wherein the reservoir further comprises a foot disposed on an exterior surface of the reservoir bottom wall; a platform configured to cover the reservoir cavity, the platform having a platform top surface, a platform bottom surface, a platform aperture extending through the platform, and a platform opening extending through the platform; and a down tube comprising a down tube bottom wall encircled by a down tube side wall and defining a down tube cavity aligned with the platform aperture, wherein the down tube comprises a slit formed through the down tube side wall.

In certain embodiments, the self-watering planter kit further comprises a gutter defining a notch that interrupts a top perimeter of the reservoir.

In certain embodiments, the self-watering planter kit further comprises a plurality of gutters each defining a notch that interrupts a top perimeter of the reservoir.

In certain embodiments, the self-watering planter kit further comprises a fill tube configured to be disposed through the platform opening. In particular embodiments, the fill tube comprises a plurality of telescopically connected segments.

In certain embodiments, the down tube comprises a plurality of slits formed through the down tube side wall.

In certain embodiments, the self-watering planter comprises a plurality of feet disposed on the exterior surface of the reservoir bottom wall.

In certain embodiments, the down tube has a down tube length and the reservoir has a reservoir length, and the down tube length corresponds to the reservoir length.

In certain embodiments, the reservoir side wall is tapered. In certain embodiments, the down tube side wall is tapered.

Further provided is a method of assembling a self-watering planter, the method comprising placing a reservoir in a cavity of a container, the reservoir having a reservoir bottom wall encircled or enclosed by a reservoir side wall, the reservoir defining a reservoir cavity bounded by the reservoir bottom wall and the reservoir side wall, wherein the reservoir further comprises an outer surface defining a gutter; and disposing a platform over the reservoir cavity, the platform having a platform top surface, a platform bottom surface, a platform aperture extending through the platform, a platform opening extending through the platform, and a down tube comprising a down tube bottom wall encircled by a down tube side wall and defining a down tube cavity aligned with the platform aperture, wherein the down tube comprises a slit formed through the down tube side wall.

In certain embodiments, the method further comprises inserting a fill tube through the platform opening.

In certain embodiments, the reservoir further comprises a foot disposed on an exterior surface of the reservoir bottom wall.

Further provided is a method of assembling a self-watering planter, the method comprising placing a reservoir in a cavity of a container, the reservoir having a reservoir bottom wall encircled or enclosed by a reservoir side wall, the reservoir defining a reservoir cavity bounded by the reservoir bottom wall and the reservoir side wall, wherein the reservoir further comprises a foot disposed on an exterior surface of the reservoir bottom wall; and disposing a platform over the reservoir cavity, the platform having a platform top surface, a platform bottom surface, a platform aperture extending through the platform, a platform opening extending through the platform, and a down tube comprising a down tube bottom wall encircled by a down tube side wall and defining a down tube cavity aligned with the platform aperture, wherein the down tube comprises a slit formed through the down tube side wall.

In certain embodiments, the method further comprises inserting a fill tube through the platform opening.

In certain embodiments, the reservoir comprises a gutter defining a notch that interrupts a top perimeter of the reservoir

Further provided is a method of watering a plant, the method comprising assembling a self-watering planter as described herein within a container, inserting soil into the down tube, planting a plant in the soil, extending the fill tube into the reservoir cavity through the platform opening, and adding water to the reservoir cavity through the fill tube.

Further provided is a method of packaging a self-watering planter kit, the method comprising nesting a first a self-watering planter kit with a second self-watering planter kit by inserting a foot of the first self-watering planter kit into a platform aperture of the second self-watering planter kit.

Further provided is a method of packaging a self-watering planter kit described herein, the method comprising disassembling the fill tube into segments and inserting the segments into the reservoir cavity, and covering the reservoir cavity with the platform, wherein the down tube extends into the reservoir cavity

Further provided is a self-watering planter kit comprising a reservoir comprising a reservoir bottom wall encircled or enclosed by a reservoir side wall, the reservoir defining a reservoir cavity; a fill tube comprising segments that are at least partially disassembled and disposed in the reservoir cavity; and a platform disposed over the reservoir cavity so as to enclose the reservoir cavity within the platform, the reservoir side wall, and the reservoir bottom wall, the platform comprising a down tube extending into the reservoir cavity.

In certain embodiments, the reservoir comprises a foot having a shape and size corresponding to a platform aperture in the platform.

In certain embodiments, the self-watering planter kit is housed within a container.

Further provided is a method of stacking a plurality of self-watering planter kits described herein, the method comprising inserting the foot of a first self-watering planter kit into the platform aperture of a second self-watering planter kit

Also provided herein is a self-watering planter kit comprising a reservoir, a platform, and a fill tube. The reservoir has a reservoir bottom wall encircled by a reservoir side wall which defines a reservoir cavity in the reservoir. The reservoir side wall has a reservoir side wall inner surface, a reservoir side wall outer surface, and a reservoir top perimeter. The reservoir side wall outer surface defines a gutter along a length of the reservoir side wall. The gutter defines a notch on the reservoir top perimeter that interrupts the reservoir top perimeter. The platform is adapted to cover the reservoir cavity. The platform has a platform top surface, a platform bottom surface, a platform aperture extending through the platform, a platform opening extending through the platform, and a down tube. The down tube has a down tube bottom wall encircled by a down tube side wall which defines a down tube cavity in the down tube. The down tube side wall has a down tube top perimeter and a slit. The down tube top perimeter is connected to the platform bottom surface and aligned with the platform aperture. The slit is formed through the down tube side wall. The fill tube is adapted to be disposed through the platform opening.

In certain examples, the gutter includes a plurality of gutters. Each of the gutters is spaced apart along the length of the reservoir side wall and has a notch on the reservoir top perimeter that interrupts the reservoir top perimeter.

In certain examples, the slit includes a plurality of slits. Each of the slits is formed through the down tube side wall.

In certain examples, the reservoir has a foot disposed on an exterior surface of the reservoir bottom wall.

In certain examples, the reservoir has a plurality of feet. Each of the feet is disposed on an exterior surface of the reservoir bottom wall.

In certain examples, the plurality of feet includes a first foot, a second foot, and a third foot.

In certain examples, the second foot is disposed between the first foot and the third foot.

In certain examples, the down tube has a down tube length and the reservoir has a reservoir length. The down tube length corresponds to the reservoir length.

In certain examples, the reservoir side wall is tapered.

In certain examples, the down tube side wall is tapered.

In certain examples, the fill tube includes a plurality of segments.

In certain examples, each of the segments of the fill tube is telescopically connected to one of the segments.

Further provided herein is a self-water planter comprising a container, a reservoir, a platform, and a fill tube. The container has a container bottom wall encircled by a container side wall which defines a container cavity. The reservoir is disposed in the container cavity. The reservoir has a reservoir bottom wall encircled by a reservoir side wall which defines a reservoir cavity in the reservoir. The reservoir side wall has a reservoir side wall inner surface, a reservoir side wall outer surface, and a reservoir top perimeter. The reservoir side wall outer surface defines a gutter along a length of the reservoir side wall. The gutter defines a notch on the reservoir top perimeter that interrupts the reservoir top perimeter. The platform covers the reservoir cavity. The platform has a platform top surface, a platform bottom surface, a platform aperture extending through the platform, a platform opening extending through the platform, and a down tube. The down tube has a down tube bottom wall encircled by a down tube side wall that defines a down tube cavity in the down tube. The down tube side wall has a down tube top perimeter and a slit. The down tube top perimeter is connected to the platform bottom surface and aligned with the platform aperture. The slit is formed through the down tube side wall. The fill tube is disposed through the platform opening.

Further provided herein is a method for assembling a self-water planter comprising disposing the reservoir into the container cavity; disposing the platform over the reservoir cavity; and disposing the fill tube through the platform opening.

Further provided herein is a method for watering a plant comprising disposing the reservoir into the container cavity; disposing the platform over the reservoir cavity; disposing the fill tube through the platform opening; disposing soil in the down tube cavity; planting a plant in the soil; and disposing water in the reservoir cavity via the fill tube.

Further provided is a self-watering planter kit including a skirt adaptor, a reservoir, a platform, and a down tube. The skirt adaptor has a skirt main body. The skirt main body defines a skirt depression. The skirt depression includes a skirt depression bottom wall and a skirt depression side wall. The skirt depression bottom wall defines a skirt opening. The reservoir is configured to be disposed in the skirt opening. The reservoir has a reservoir bottom wall encircled or enclosed by a reservoir side wall. The reservoir defines a reservoir cavity bounded by the reservoir bottom wall and the reservoir side wall. The reservoir side wall defines a reservoir top perimeter. The reservoir top perimeter includes a reservoir outer lip extending from the reservoir top perimeter and enclosing the reservoir top perimeter. The reservoir outer lip is configured to be disposed on the skirt depression bottom wall. The reservoir outer lip defines a reservoir depression including a reservoir depression bottom wall and a reservoir depression side wall. The platform is configured to be disposed on the reservoir depression bottom wall. The platform has a platform top surface, a platform bottom surface, a platform aperture extending through the platform, and a platform opening extending through the platform. The down tube includes a down tube bottom wall encircled by a down tube side wall and defining a down tube cavity aligned with the platform aperture. The down tube comprises a slit formed through the down tube side wall.

Further provided is a method of assembling a self-watering planter, the method comprising: positioning a skirt adaptor in a cavity of a container, the skirt adaptor having a skirt main body defining a skirt depression, the skirt depression having a skirt depression bottom wall and a skirt depression side wall, the skirt depression bottom wall defining a skirt opening; positioning a reservoir in the skirt opening, the reservoir having a reservoir bottom wall encircled or enclosed by a reservoir side wall, the reservoir defining a reservoir cavity bounded by the reservoir bottom wall and the reservoir side wall, the reservoir side wall defining a reservoir top perimeter, the reservoir top perimeter including a reservoir outer lip extending from the reservoir top perimeter and enclosing the reservoir top perimeter, the reservoir outer lip configured to be disposed on the skirt depression bottom wall, and the reservoir outer lip defining a reservoir depression including a reservoir depression bottom wall and a reservoir depression side wall; and positioning a platform on the reservoir depression bottom wall, the platform having a platform top surface, a platform bottom surface, a platform aperture extending through the platform, a platform opening extending through the platform, and a down tube comprising a down tube bottom wall encircled by a down tube side wall and defining a down tube cavity aligned with the platform aperture, wherein the down tube comprises a slit formed through the down tube side wall.

Various aspects of this invention will become apparent to those skilled in the art from the following detailed description of the preferred embodiment, when read in light of the accompanying drawings.

### BRIEF DESCRIPTION OF THE DRAWINGS

The patent or application file may contain one or more drawings executed in color and/or one or more photographs. Copies of this patent or patent application publication with color drawing(s) and/or photograph(s) will be provided by the U.S. Patent and Trademark Office upon request and payment of the necessary fees.

FIG. 1 is a perspective view of an embodiment of a self-watering planter in accordance with the present disclosure.

FIG. 2 is a perspective view of a container employed in the self-watering planter illustrated in FIG. 1.

FIG. 3A is a photograph showing an embodiment of a container for a self-watering planter that includes a platform engagement surface (a rim) protruding from a side wall and encircling the cavity in the container. FIG. 3B is a photograph showing an embodiment of the container including a platform engagement surface protruding from a side wall, where a hand is pointing at the platform engagement surface.

FIG. 4 is a bottom plan view of an embodiment of a platform for a self-watering planter in accordance with the present disclosure.

FIG. 5 is a photograph showing a perspective view of an embodiment of a platform for a self-watering planter, where a sealing member is attached to the platform.

FIG. 6 is a side elevational view of an embodiment of a down tube for a self-watering planter.

FIG. 7 is a photograph showing a perspective view of the platform having an attached sealing member from FIG. 5, as well as a portion of a down tube as illustrated in FIG. 6.

FIG. 8 is a perspective view of a down tube attached to a platform, and a fill tube in isolation.

FIG. 9 is a photograph showing a perspective view of the platform with an attached sealing member and attached down tube as seen in FIG. 7 inserted into a container of a self-watering planter.

FIG. 10 is a perspective view of a platform with a down tube attached to the platform and further including a fill tube extending through an opening in the platform.

FIG. 11 is a photograph showing a perspective view of an assembly having the platform with the down tube attached to the platform and the fill tube extending through the opening in the platform as shown in FIG. 10 and further including a sealing member attached to the platform and sleeve attached to the fill tube. The assembly is shown outside of a container.

FIG. 12 is a photograph showing a perspective view of a platform with a sealing member attached to the platform and the fill tube extending through the platform with the fill tube including a sleeve that engages the platform.

FIG. 13 is a photograph showing a top-down view of a self-watering planter, where the platform is supported by, and rests on, a platform engagement surface in the container without a sealing member.

FIG. 14 is a perspective view of the self-watering planter from FIG. 1 further including the presence of water in a first environment inside the container and the presence of soil in a second environment inside the container.

FIG. 15 is a perspective view of an embodiment of a self-watering planter kit in accordance with the present disclosure.

FIG. 16 is a side elevational view of an embodiment of a reservoir of the self-watering planter kit in accordance with the present disclosure.

FIG. 17 is a top plan view of an embodiment of the reservoir of the self-watering planter kit in accordance with the present disclosure.

FIG. 18 is an exploded view of an embodiment of a self-watering planter in accordance with the present disclosure.

FIG. 19 is a side perspective view of an embodiment of the self-watering planter in accordance with the present disclosure.

FIG. 20 is a sectional view of an embodiment of a self-watering planter in accordance with the present disclosure.

FIG. 21A is a sectional view of an embodiment of a self-watering planter in accordance with the present disclosure that depicts how the water is directed during an overflow.

FIG. 21B is a sectional view of an embodiment of a self-watering planter in accordance with the present disclosure that depicts the direction of water being filled into the reservoir and how water is wicked from the reservoir into the soil within the down tube.

FIG. 22 is a perspective view of embodiments of the fill tube for a self-watering planter kit in accordance with the present disclosure.

FIG. 23 is a perspective view of an embodiment of the self-watering planter kit in a stored configuration for storage.

FIG. 24A is a perspective view of the self-watering planter kit and a container in a stacking configuration for storage.

FIG. 24B is a perspective view of the self-watering planter kit and a container in an alternative stacking configuration for storage.

FIG. 25 is a sectional view of an embodiment of the self-watering planter kit in a stacking configuration for storage.

FIG. 26 is side elevational view of an embodiment of the self-watering planter kit in accordance with the present disclosure.

FIGS. 27-29 are views showing the self-watering planter in accordance with the present disclosure during different stages of an assembly process. FIG. 27 shows the reservoir being disposed in the skirt adaptor, and the platform being disposed in the reservoir. FIG. 28 shows the reservoir partially disposed in the skirt adaptor, and the platform partially disposed in the reservoir. FIG. 29 shows the reservoir fully disposed in the skirt adaptor, and the platform fully disposed in the reservoir. The thick arrows designate the movement and direction of each component in the assembly process.

FIG. 30 is a sectional view of an embodiment of the platform for the self-watering planter kit in accordance with the present disclosure.

FIG. 31 is a sectional view of an embodiment of the platform, the fill tube, and a fill tube sheath of the self-watering planter kit in accordance with the present disclosure.

FIG. 32 is an illustration showing an embodiment the fill tube and the fill tube sheath in accordance with the present disclosure.

### DETAILED DESCRIPTION

The present disclosure relates to an improved self-watering planter, kits, and associated methods.

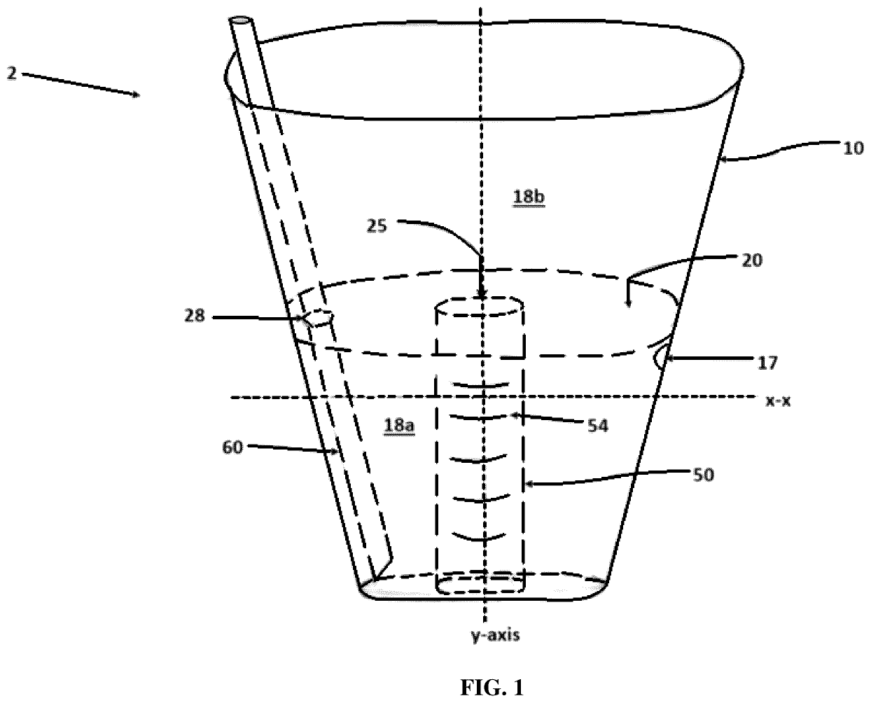

Referring now to the drawings, there is illustrated in FIG. 1 an embodiment of a self-watering planter 2. The self-watering planter 2 may include a container 10, a platform 20, a down tube 50 (which may also be referred to a soil tube), a fill tube 60, and, optionally, a sealing member 40. As will be described below, the self-watering planter 2 can be easily assembled by a person without the use of any tools or glue.

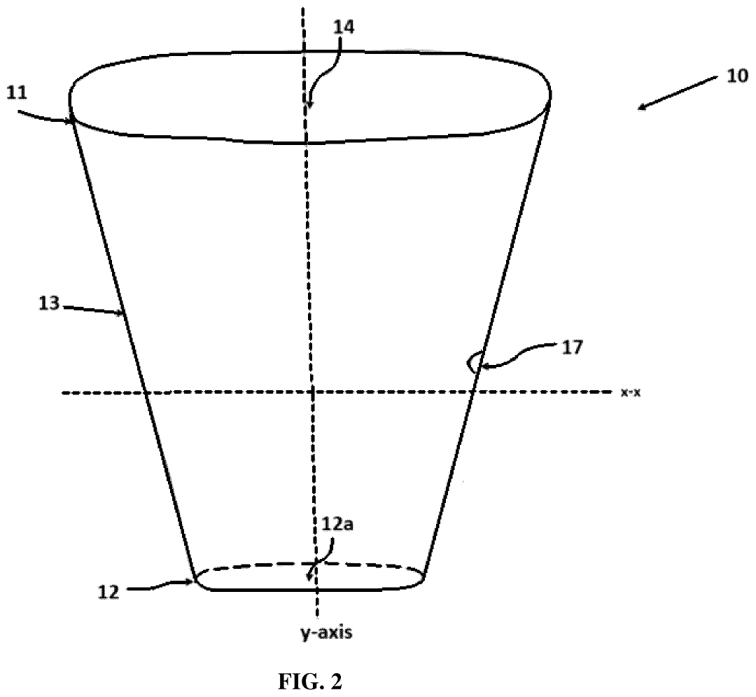

Referring to FIG. 2, the self-watering planter 2 may include a container 10 that functions to hold water, growing medium (i.e., soil), and plants. In some embodiments, the container 10 may be a pot. The container 10 may have a top 11, a bottom 12, and at least one side wall 13 that extends between the top 11 and the bottom 12. The top 11 may include an orifice 14 and the bottom 12 may include a bottom wall 12a. The side wall 13 may be tapered. The bottom wall 12a and the side wall 13 together define a cavity 16 in the container 10 which is accessible via the orifice 14 at the top 11 of the container 10.

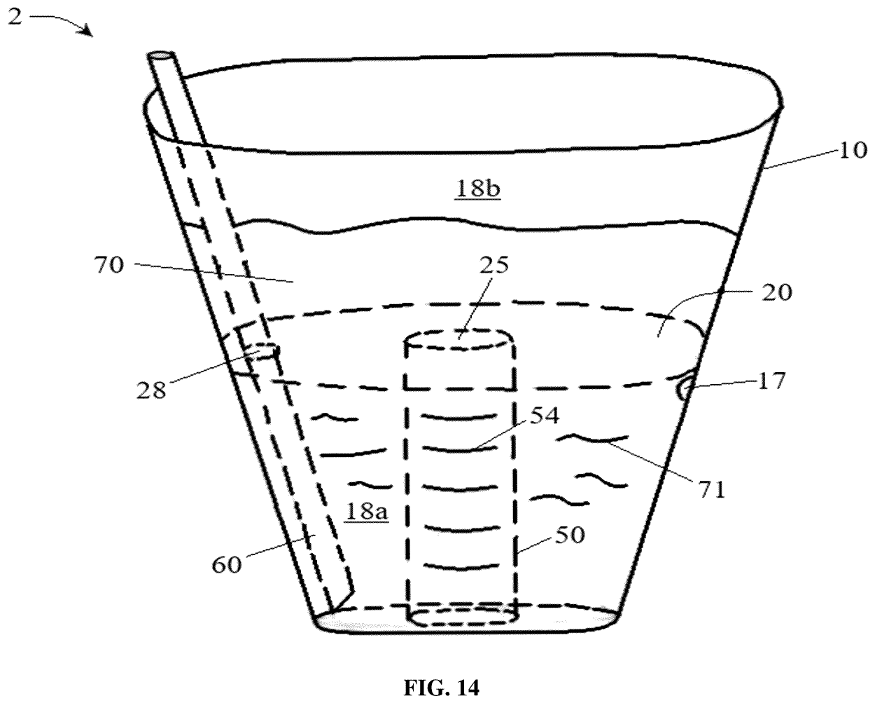

The container 10 may have an open top 11 and a closed bottom 12. A container 10 having a closed bottom 12 offers numerous advantages over conventional containers. Conventional containers feature a drainage hole in the bottom of the container which allows vital plant nutrients to leech through the soil and be washed from the container during watering. These nutrients can also stain surfaces such as pool decks or patios, which is not desirable. The container 10 having a closed bottom 12, on the other hand, beneficially retains water and nutrients in the cavity 16, as shown in FIG. 14, while preventing damage and staining to the surrounding environment through undesirable leaching.

In the embodiment illustrated in FIGS. 1-2, the container 10 extends axially about a y-axis which passes through the center of the container 10 from the bottom 12 to the top 11. The container 10 has a circular cross-section, taken along line x-x, but in other embodiments the container 10 may have a cross-section of another shape such as rectangular, triangular, or elliptical. The container 10 may include side walls 13 that taper radially inward along the y-axis from the top 11 of the container 10 to the bottom 12 of the container 10. However, in other embodiments, the side walls 13 may taper radially outward along the y-axis from the top 11 of the container 10 to the bottom 12 of the container 10 or, alternatively, may not taper at all.

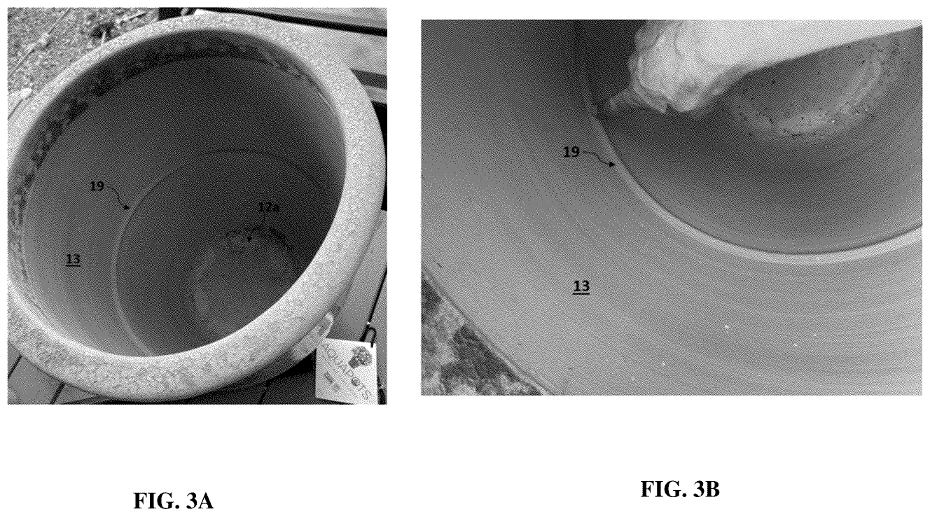

Referring now to FIGS. 3A-3B, the side wall 13 may include a platform engagement surface 19. The platform engagement surface 19 may be formed from an inner surface of the side wall 13 projecting radially inward toward the y-axis. The platform engaging surface 19 may be produced using with the mold for the container 10, and therefore may be of the same material as the container 10. The platform engagement surface 19 may act as a rim on which the platform 20 sits. The platform engagement surface 19 may encircle the cavity 16. The platform engagement surface 19 together with the platform 20 may form a tight seal without the need for additional material or sealants. The platform engagement surface 19 also allows for the platform 20 to be easily removed from the self-watering planter 2 for easy cleaning, because the platform 20 does not need to be adhered to the platform engagement surface 19 in order to form a tight seal.

As best illustrated in FIGS. 1-2, the container 10 may include a hole 17 through the side wall 13. However, in other embodiments, the container 10 may include more than one hole 17 through the side wall 13 or side walls. The hole 17 may function as a drain to remove excess water from the container 10 to prevent overfilling the container 10 with water. The location of the hole 17 in relation to the bottom wall 12a determines the amount of water the container 10 can store at a time. In some embodiments, the hole 17 is below the platform engagement surface 19 in the side wall 13. In other words, the hole 17 may be positioned between the bottom wall 12a and the platform engagement surface 19. In such embodiments, the hole 17 may be substantially nearer the platform engagement surface 19 than the bottom wall 12a.

The container 10 can be made of a variety of materials, including but not limited to stoneware glazed ceramics. The use of a ceramic container 10 provides advantages in appearance and durability over conventional self-watering planters that include plastic containers. For example, a ceramic container 10 can be recycled, unlike plastic containers. At the end of its life, the ceramic can be ground up and composted, turned into soil, or made into a gravel mix. The container 10 can be any suitable size and shape. For example, in the embodiment shown in FIGS. 1-2, the container 10 has a tapered side wall 13 that defines a cavity 16 having a circular cross-section. However, the container 10 can have a plurality of side walls 13 which may or may not taper and which define a cavity 16 having a cross-section of various shapes, such as rectangular, elliptical, or triangular. As seen in FIGS. 1-2, the circular cross-section of the container 10 may taper with the side walls 13.

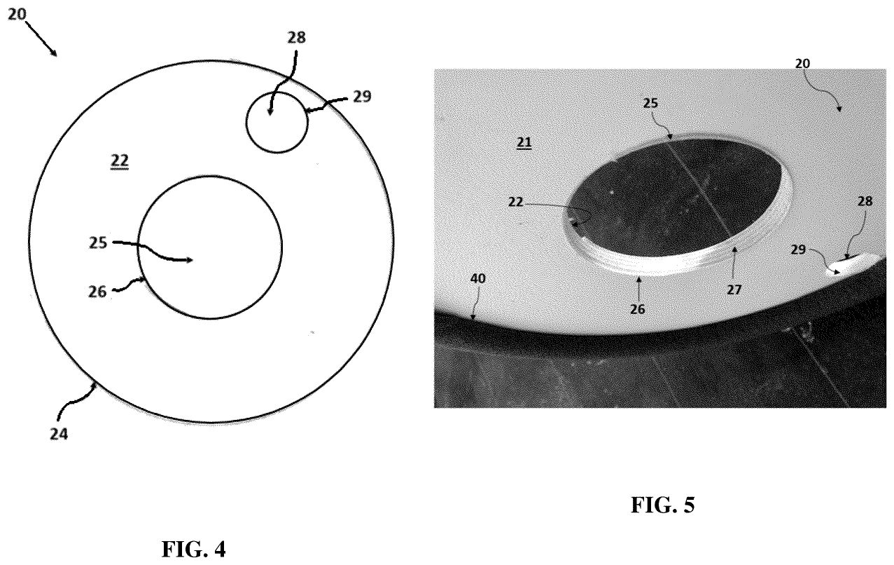

Referring now to FIGS. 1, 4, 5, the self-watering planter 2 may further include a platform 20. The platform 20 may also be referred to as a disk. However, it is understood that the platform need not be circular in shape. Rather, the platform 20 may take any suitable shape so as to fit within the container 10. The platform 20 can be made of a variety of materials such as, but not limited to, plastic. As best shown in FIGS. 4-5, and 8, the platform 20 may have a first surface 21 and a second surface 22 with a body 23 having a thickness that extends between the first surface 21 and the second surface 22. The platform 20 may have an outer wall 24 that extends around the perimeter of the platform 20. Advantageously, if the container 10 is accidentally broken, the platform 20 can be reused in a different container 10 to form a new self-watering planter 2.

Referring still to FIGS. 4-5, the platform 20 may further include an aperture 25. The aperture 25 may extend through the platform 20 from the first surface 21 to the second surface 22. The aperture 25 is defined by aperture walls 26 which are part of the platform 20. The size and shape of the aperture 25 can vary. In the embodiment depicted in FIGS. 4-5, the aperture walls 26 define an aperture 25 having a circular shape. The aperture 25 can be located anywhere on the platform 20. However, it is beneficial to place the aperture 25 near the center of the platform 20, as will be explained below.

Referring now to FIGS. 5-7, the platform 20 may include a down tube retaining feature 27 to releasably attach the down tube 50 to the platform 20. The down tube retaining feature 27 can take a variety of forms such as a threaded surface, a snap fit, or other releasable attachment mechanism. As best illustrated in FIGS. 5 and 7, the down tube retaining feature 27 may comprise a threaded surface located on the aperture walls 26 which is configured to mate with a threaded surface of the down tube 50, as will be explained below. The threaded surface of the down tube retaining feature 27 can be made, for example, with a tap and die set. However, the down tube retaining feature 27 is not limited to being a threaded surface, and may be, for example, a snap fit, or other releasable attachment mechanism. Many other down tube retaining features 27 are possible and encompassed within the scope of the present disclosure.

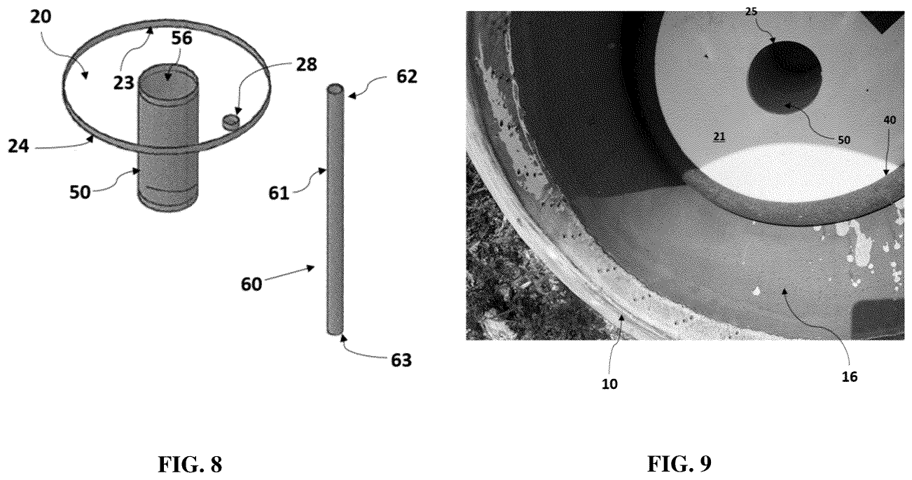

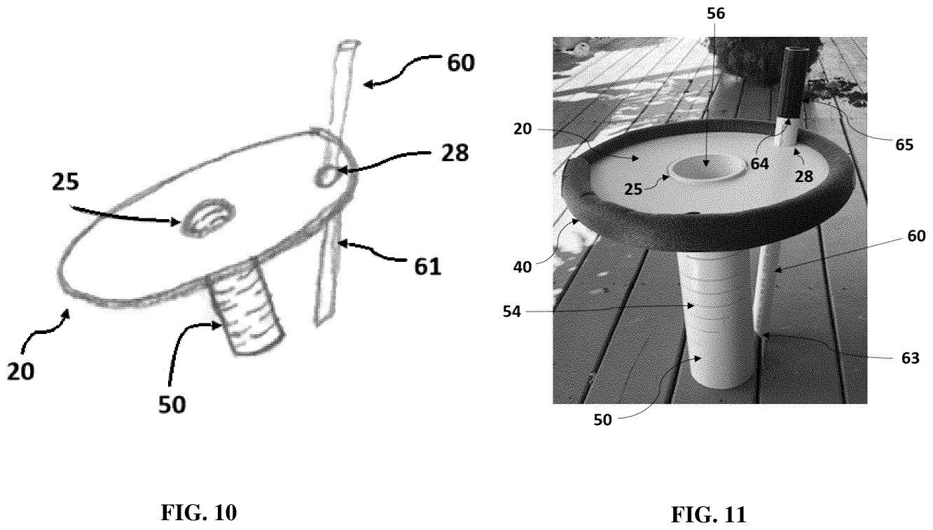

Referring now to FIGS. 2, 8, 10-11, the platform 20 may further include an opening 28. The opening 28 may extend through the platform 20 from the first surface 21 to the second surface 22. The opening 28 is defined by opening walls 29 which are part of the platform 20. The size and shape of the opening 28 can vary. For example, in the embodiment depicted in FIGS. 2 and 8, the opening 28 is offset from the outer wall 24 that extends around the perimeter of the platform 20. In this case, the opening 28 is completely bounded by the body 23 of the platform 20, as shown in FIGS. 4 and 10. In the alternative, the opening 28 can be located at the outer wall 24 that extends around the perimeter of the platform 20. In this case, the opening 28 is only partially bounded by the body 23 of the platform 20. In either case, the opening 28 is configured to receive the fill tube 60.

The platform 20 may optionally include a fill tube retaining feature to releasably attach the fill tube 60 to the platform 20. The optional fill tube retaining feature can take a variety of forms including, but not limited to, a form fit, a threaded surface, a snap fit, or other releasable attachment mechanism.

The platform 20 may have a size and shape configured to match the cross-section of the container 10 as defined by the side walls 13. In the embodiment illustrated in FIGS. 1, 9, and 13, the platform 20 is disk-shaped to match the circular cross-section of the container 10. As will be explained below, the platform 20 may be inserted into the cavity 16 in the container 10. The outer walls 24 of the platform 20 may engage the inner surface of the side walls 13 of the container 10 to stabilize the platform 20 in the cavity 16 and to divide the container 10 into a first environment 18a and a second environment 18b. In some embodiments, the second surface 22 of the platform 20 may cooperate with the platform engagement surface 19 of the side wall 13 to support the platform in the cavity 16. The platform 20 may thus be sized to fit snugly within the container 10 to form a tight seal without the need for additional materials or sealants.

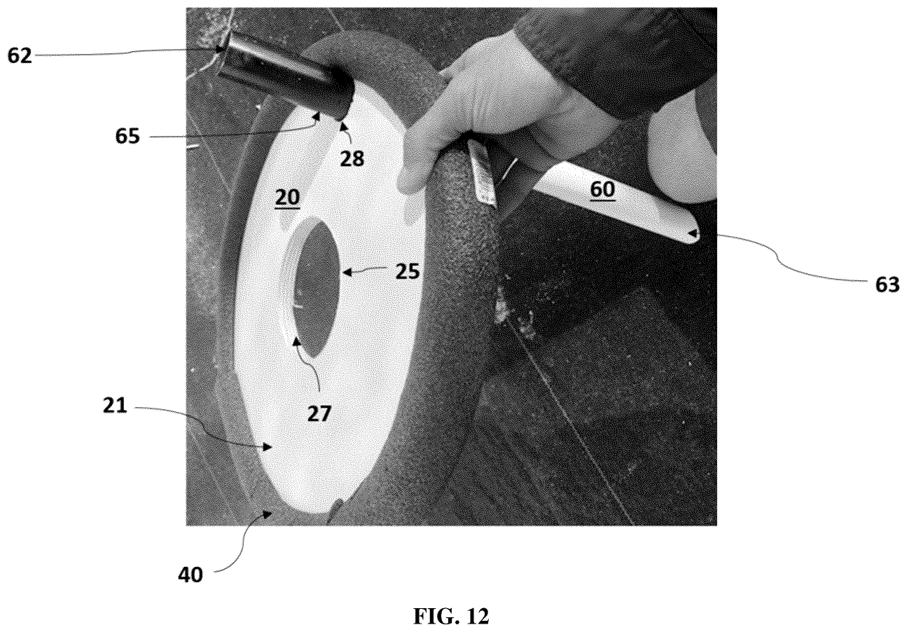

Referring now to FIGS. 9, 11-12, the self-watering planter 2 may optionally further include a sealing member 40. As noted above, the sealing member 40 is not necessary when the container 10 includes a platform engagement surface 19. Thus, the sealing member 40 is an optional component of the self-watering planter 2. In any event, the sealing member 40 can be an insulating foam or some other deformable material. As best illustrated in FIGS. 11-12, the sealing member 40 may be attached to the platform 20 at the outer wall 24 so that the sealing member 40 extends around the perimeter of the platform 20. However, in some embodiments, the sealing member 40 may not completely extend around the perimeter of the platform 20.

The sealing member 40, if included, may provide several benefits to the self-watering planter 2. First, the sealing member 40 may help stabilize the platform 20 in the cavity 16 in the container 10. Even containers of the same size can have slightly different dimensions resulting from the manufacturing process. The sealing member 40 can account for slight deviations between containers 10 by providing a deformable material that can be compressed between the side wall 13 of the container 10 and the outer wall 24 of the platform 20 to form a snug fit between the container 10 and the platform 20, as shown in FIG. 9. Second, the sealing member 40 may form a seal between the platform 20 and the container 10 to form a physical barrier that separates the container 10 into a first environment 18a, which may act as a water reservoir, and a second environment 18b, which may contain plant material and a growing medium, such as soil.

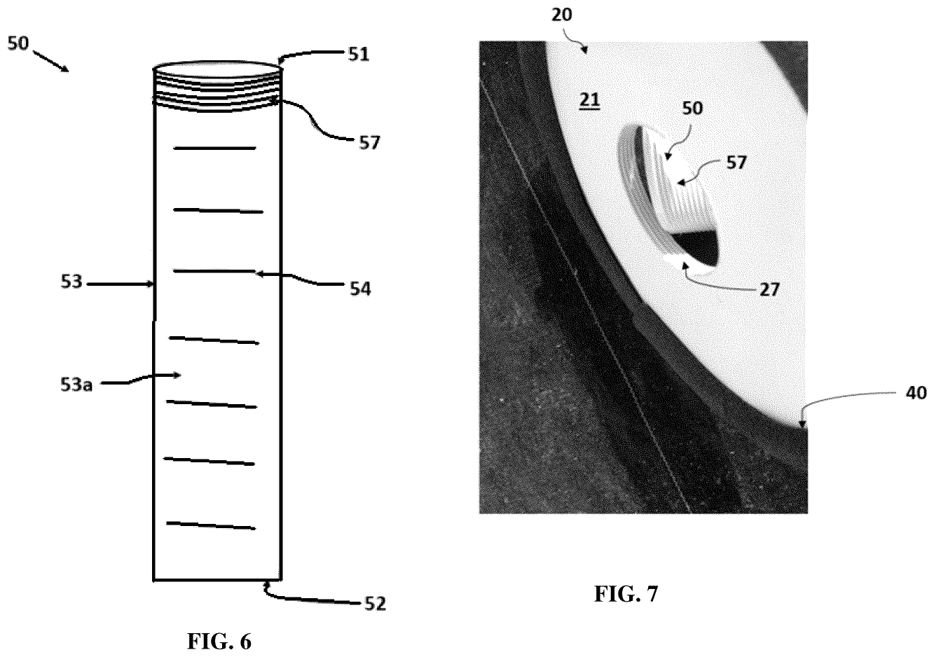

Referring now to FIGS. 1, 6, 8, 11, the self-watering planter 2 may further include a down tube 50. The down tube 50, which may also be called a soil tube, can be made of a variety of materials, such as, but not limited to, PVC pipe. As best shown in FIGS. 6 and 11, the down tube 50 may have a first end 51 and a second end 52 with a down tube body 53 spanning a linear length between the first end 51 and the second end 52. The down tube 50 may have a cylindrical body 53 with a body wall 53a defining a space 56 in the down tube 50, as shown in FIGS. 8 and 11. As will be explained below, the first end 51 of the down tube 50 can engage the platform 20 and the second end 52 of the down tube 50 can engage the bottom wall 12a of the container 10. When in place, the down tube 50 may be filled with soil in which a plant's roots may grow and wick up water from the first environment 18a.

Though the down tube 50 is depicted in FIGS. 1, 6, 8, 10, 11 as being tubular in shape, the down tube may have a variety of shapes. For example, the down tube 50 may have a cone shape. Advantageously, a cone shape provides the benefit of being able to nest multiple down tubes 50 together for more efficient packaging and shipping.

Referring now to FIG. 7, the down tube 50 may include a platform retaining feature 57 to releasably attach the down tube 50 to the platform 20. The platform retaining feature 57 can take a variety of forms such as a threaded surface, a snap fit, or other releasable attachment mechanism. However, other platform retaining features 57 are possible and encompassed within the scope of the present disclosure. The platform retaining feature 57 is configured to cooperate with the down tube retaining feature 27 to releasably attach the down tube 50 to the platform 20. In the embodiment depicted in FIG. 7, the platform retaining feature 57 comprises a threaded surface located at the first end 51 which is configured to mate with the threaded surface of the down tube retaining feature 27 located on the aperture walls 26. As shown in FIG. 7, the down tube 50 is externally threaded as the threaded surface is located on the outer surface of the body 53 and the platform 20 is internally threaded as the threaded surface is located on the aperture walls 26 within the perimeter of the of platform 20. The threaded surface of the platform retaining feature 57 and the threaded surface of the down tube retaining feature 27 can be made, for example, using a tap and die set. A user can releasably attach the down tube 50 to the platform 20 by manually twisting the first end 51 of the down tube 50 into the aperture 25 in the platform 20.

The down tube retaining feature 27 and the platform retaining feature 57 provide many advantages. First, the retaining features 27 and 57 allow a user to attach the down tube 50 to the platform 20 without tools or glue. Thus, a user does not need to worry about having the right tools to attach the down tube 50 to the platform 20. Moreover, the user does not need to deal with the hassle of glue, such as waiting for the glue to set and hoping that when the glue sets the platform 20 is still properly oriented relative to the down tube 50. Second, the retaining features 27 and 57 allow the down tube 50 to be easily detached from the platform 20 without causing damage to the down tube 50 or the platform 20. If the down tube 50 is glued to the platform 20, it may be impossible to remove the down tube 50 from the platform 20 without causing irreversible damage to the down tube 50 and/or the platform 20 so that the down tube 50 and platform 20 cannot be reused. The present disclosure ensures that the down tube 50 can be reattached to the platform 20, which reduces waste because the down tube 50 and the platform 20 can be reused in the self-watering planter 2. Moreover, the simplicity with which the retaining features 27 and 57 can be disengaged, such as by unscrewing the down tube 50 from the platform 20, make cleaning the self-watering planter 2 simple. The down tube 50 is detached from the platform 20, such as by unscrewing the down tube 50 from the platform 20, and both the down tube 50 and the platform 20 can be removed from the container 10 allowing the interior of the container 10 to be cleaned. Third, the retaining features 27 and 57 make the platform 20 and the down tube 50 easier to obtain by a consumer and easier to replace because the down tube 50 and the platform 20 can each be purchased separately by the consumer and assembled by the consumer on-site. Fourth, the retaining features 27 and 57 make the platform 20 and the down tube 50 easier to ship because a pre-assembled or integral blow molded down tube-platform unit is bulky and more prone to damage during transport.

In alternative embodiments, the platform 20 and the down tube 50 are formed from a single molded piece. In such embodiments, there is no need for a down tube retaining feature 27 or a platform retaining feature 57 because the platform 20 and the down tube 50 are already integrally connected. When the platform 20 and the down tube 50 are a single piece, the single piece may be in the form of a tapered cone. Alternatively, the down tube 50 may itself by in the form of a tapered cone. A tapered cone shape provides an advantage for packaging and shipping by allowing for multiple pieces to be nested together and therefore packaged efficiently.

The second end 52 of the down tube 50 may be covered by a cap, plug, integral surface, or the like, or may engage another surface. However, this is not necessary, and the second end 52 of the down tube 50 does not need to be capped or plugged. The second end 52 of the down tube 50 can engage an inner surface of the bottom wall 12a of the container 10, as shown in FIGS. 1 and 14. Having the down tube 50 contact the inner surface of the bottom wall 12a has several advantages. First, the down tube 50 can serve as a structural support for the platform 20 as the aperture 25 moves closer to the center of the platform 20. Second, the bottom wall 12a of the container 10 can cover the second end 52 of the down tube 50 to close the second end 52. This may be particularly important because the down tube 50 may be filled with soil that should remain in the down tube 50. Soil may also be added on top of the platform 20, in the second environment 18b. Plants may be put into the soil in the second environment 18b, such that the roots of the plants soak up water that wicks up through the soil in the down tube 50. However, it is not strictly necessary that the second end 52 of the down tube 50 engages the bottom wall 12a of the container 10. It is not necessary that the down tube 50 extends all the way to the bottom wall 12a of the container 10.

Referring now to FIGS. 6, 11, the down tube 50 may further include at least one slit 54 through the wall 53a of the down tube body 53 between the first end 51 and the second end 52. In the embodiment illustrated in FIGS. 6 and 11, the down tube 50 has a plurality of slits 54 spaced along the linear length of the down tube body 53 between the threaded surface of the platform retaining feature 57 at the first end 51 and the second end 52. The slits 54 may be spaced in intervals, such as every one inch of linear length, but are not so limited. The slits 54 may allow water to seep into the down tube 50 where it can be absorbed by the soil that is packed into the down tube 50 and distributed to the roots of any planted matter. Each slit 54 may be any shape or size of opening that is configured to allow passage of a liquid, such as water, therethrough, but also keep soil retained within the down tube 50. The slits 54 are configured to allow water into the down tube 50 from the first environment 18a while keeping soil in the down tube 50 from exiting the down tube 50 into the first environment 18a.

Referring now to FIGS. 1, 8, 12, the self-watering planter 2 may further include a fill tube 60. The fill tube 60 can be made of a variety of materials such as PVC pipe. As best shown in FIGS. 10-12, the fill tube 60 may have a hollow cylindrical body 61 extending between a first end 62 and a second end 63. However, the body 61 does not have to be cylindrical. For example, the fill tube 60 could be conical. Many shapes of the fill tube 60 are possible and encompassed within the scope of the present disclosure. The first end 62 and the second end 63 may be opened to permit the passage of fluid through the fill tube 60 from the first end 62 to the second end 63. Thus, the fill tube 60 may be used to insert a fluid such as water, or small solids such as fertilizer, for example a slow release fertilizer, into the first environment 18a.

The fill tube 60 may have a size and shape that allows the fill tube 60 to be inserted into the opening 28 in the platform 20 with some length of the body 61 extending through the platform 20, as shown in FIGS. 10-12. As best illustrated in FIGS. 11-12, the second end 63 of the fill tube 60 may be cut at an angle for reasons that will be explained below. However, it is not necessary that the second end 63 be cut at an angle.

The fill tube 60 may have a protruding rim 64 that extends radially away from the center of the fill tube 60. The protruding rim 64 may be formed integral with the fill tube 60. Or, as illustrated in FIG. 11, the rim 64 may be created by attaching a sleeve 65 around the outer surface of the body 61 of the fill tube 60. As best illustrated in FIG. 12, a surface of the protruding rim 64 may be adapted to engage the first surface 21 of the platform 20 when the fill tube 60 extends through the opening 28 in the platform 20. However, this is not strictly necessary. Additionally, the outer surface of the body 61 of the fill tube 60 may be sized and shaped to frictionally engage the surface of the opening walls 29. In this manner, the fill tube 60 may be positively positioned within the opening 28 in the platform 20 and be supported on the platform 20.

In alternative embodiments, the self-watering planter 2 does not include a fill tube 60. Instead of using a fill tube to add water or fertilizer to the first environment 18a, a user may simply add water to the plant and soil in the second environment 18b and the water may filter through the soil into the first environment 18a through the slits 54 where the water may be stored until wicked up by the soil. In such embodiments, the platform 20 may not include the opening 28. Such embodiments may be particularly useful for smaller sized containers 10, such as for house plants.

The self-watering planter 2 can be easily assembled without the use of tools or glue. If included, the sealing member 40 may be attached to the outer wall 24 of the platform 20 so that the sealing member 40 extends around the perimeter of the platform 20, as shown in FIGS. 11-12. The platform 20 may be packaged and shipped with the scaling member 40 already attached.

The down tube 50 may be attached to the platform 20 by first axially aligning the first end 51 of the down tube 50 with the aperture 25 in the platform 20. Once aligned, the first end 51 of the down tube 50 may be inserted into the aperture 25 such that the platform retaining feature 57 on the down tube 50 engages the down tube retaining feature 27 on the platform 20. The down tube 50 is then rotated relative to the platform 20 to releasably attach the down tube 50 to the platform 20, as shown in FIGS. 10-11. In the embodiment depicted in FIG. 7, the down tube retaining feature 27 and the platform retaining feature 57 can be threaded surfaces such that the down tube 50 is rotated relative to the platform 20 to attach the down tube 50 to the platform 20.

It is advantageous to have the down tube 50 as a separate component from the platform 20. A down tube 50 that is integral with the platform 20 can limit or prevent insertion of the integral structure into certain container designs. A down tube 50 that is separate from the platform 20 is not so limited. In the present disclosure, the down tube 50 may be attached to the platform 20 from inside the cavity 16 in the container 10, which is more accommodating for various container dimensions. Alternatively, the down tube 50 can be attached to the platform 10 outside the container 10 and then the combined structure can be placed into the container 10.

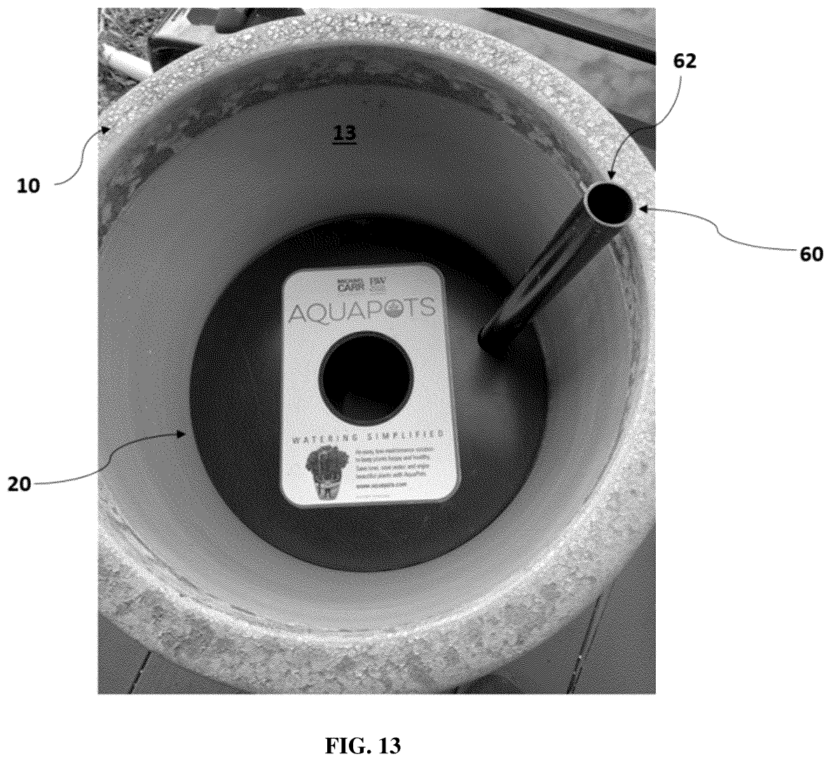

The assembled structure comprising the down tube 50 and the platform 20 may be lowered into the container 10 until the outer walls 24 of the platform 20, or the sealing member 40, if included, frictionally engages the side walls 13 of the container 10, as shown in FIGS. 13-14 (without the sealing member 40), until the second end 52 of the down tube 50 is firmly resting on the inner surface of the bottom wall 12a, as shown in FIG. 14, and/or until the platform 20 is resting on the platform engagement surface 19. In some embodiments, the platform 20 is retained in the container 10 through frictional engagement between the outer walls 24 of the platform 20, or sealing member 40 if included, and the inner surface of the side wall 13 and the platform 20 is also supported by the down tube 50. In other embodiments, the platform 20 engages and rests on the platform engagement surface 19 with the platform engagement surface 19 supporting the weight of the platform 20, as shown in FIG. 13. As best illustrated in FIGS. 1 and 14, the platform 20 may divide the cavity 16 into a first environment 18a, which may contain water, and a second environment 18b, which may contain a growing medium. The platform 20 should be retained in the container 10 at a greater distance from the bottom wall 12a than the hole 17. This ensures that the hole 17 is obstructed by the platform 20 so that excess water in the first environment 18a may be drained from the container 10 through the hole 17 in the side wall 13.

The fill tube 60 may be attached to the platform 20 before inserting the platform 20 into the cavity 16 or after inserting the platform 20 into the cavity 16. The second end 63 of the fill tube 60 may be inserted through the opening 28 in the platform 20. As best illustrated in FIGS. 1 and 14, the second end 63 may continue to be extended through the platform 20 into the container 10 until the second end 63 contacts the inner surface of the bottom wall 12a. It may be advantageous to have the second end 63 cut at an angle so that the second end 63 does not sit flush against the inner surface of the bottom wall 12a. This may ensure that the second end 63 is not physically blocked by the inner surface of the bottom wall 12a so that fluid can pass through the fill tube 60 and into the first environment 18a. The fill tube 60 may be inserted through the opening 28 in the platform 20 until a surface of the protruding rim 64, if present, engages the first surface 21 of the platform 20 to restrict further insertion of the fill tube 60 into the container 10.

Referring now to FIG. 14, once the self-watering planter 2 has been assembled to include at least the platform 20 with the down tube 50 and the fill tube 60 attached, the first and second environments 18a and 18b can be developed. Soil 70 can be packed into the down tube 50 and above the first surface 21 of the platform 20 to form a layer of soil 70 in the second environment 18b where plants can be planted, as shown in FIG. 14. Water 71 can be poured through the fill tube 60 into the first environment 18a where the water 71 is stored until taken up by plants planted in the self-watering planter 2, as shown in FIG. 14. The self-watering planter 2 can hold a very large reservoir of water 71 in the first environment 18a. Any excess water 71 is drained out of the first environment 18a through the hole 17 in the side wall 13 of the container 10. The water 71 may seep through the slits 54 in the down tube 50 where the water is absorbed by the soil 70 that is packed into the down tube 50. The soil 70 acts as a wick that distributes the water 71 into the second environment 18b where the water 71 and any nutrients therein (e.g., from fertilizer added to the first environment 18a) can be absorbed by the root base of a plant in the self-watering planter 2.

The size of the down tube 50 can regulate how much water 71 is absorbed and distributed to a plant planted in the self-watering planter 2. In some embodiments, the self-watering planter 2 can last two or more weeks between watering, even in full sun. The self-watering planter 2 provides an incredibly efficient use of water 71, while keeping all of the nutrients in the soil 70 instead of washing them away. Moreover, the self-watering planter 2 can hold a very large reservoir of water in the first environment 18a so that larger-sized self-watering planters 2 can withstand incredible wind forces when full of water 71. The self-watering planter 2 further provides a beneficial environmental impact by eliminating water waste and fertilizer run-off.

Advantageously, the self-watering planter 2 also provides for self-watering capability without the staining typically caused by conventional self-watering pots that have draining holes in the bottom. The self-watering planter 2 is also easy to maintain, where a user may simply refill the second environment 18b with water every one to two weeks or so, depending on factors such as the type and size of plant in the self-watering planter 2 and environmental conditions. Water 71 will come out of the hole 17 when the second environment 18b is sufficiently filled, providing an easy way for a user to know when the self-watering planter 2 is filled. And the self-watering planter 2 is easily assembled and disassembled for cleaning, without the need for any tools or adhesives.

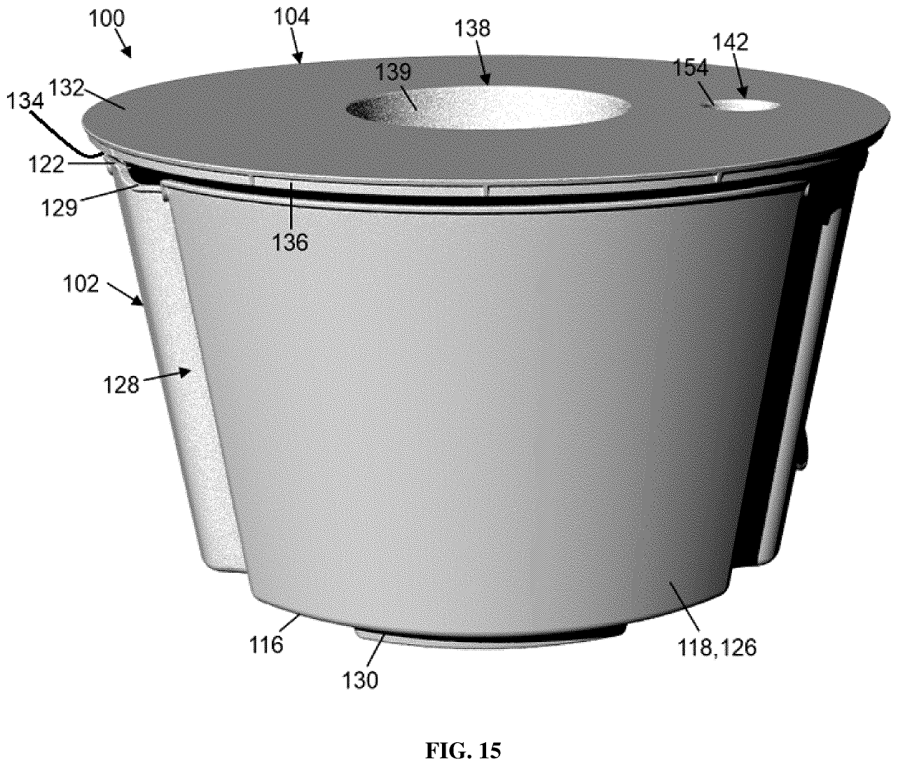

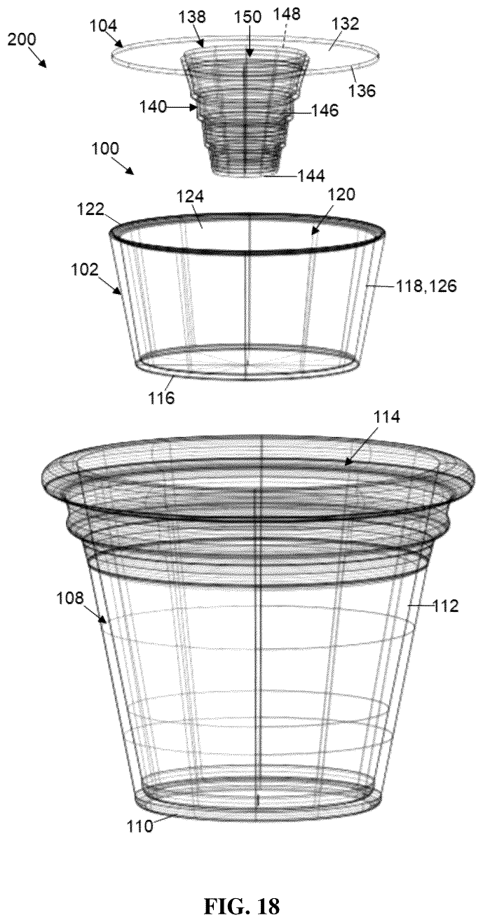

Referring now to FIGS. 15 and 18-21B, an embodiment of a self-watering planter kit 100 is depicted. The self-watering planter kit 100 may include a reservoir 102, a platform 104, and a fill tube 106. As described below, the self-watering planter kit 100 can be easily assembled with a container 108 to form a self-watering planter 200 by a person without the use of any tools or glue. Advantageously, this can allow a standard container 108 to be converted into the self-watering planter 200. Non-limiting examples of containers 108 include planters, vases, and pots. FIGS. 18-21B and 24-25 illustrate different examples of the container 108. However, it should be appreciated that other vessels adapted to hold plants may also be substituted for the container 108, provided that the container 108 includes a container bottom wall 110 encircled or enclosed by a container side wall 112. The container bottom wall 110 and the container side wall 112 define a container cavity 114.

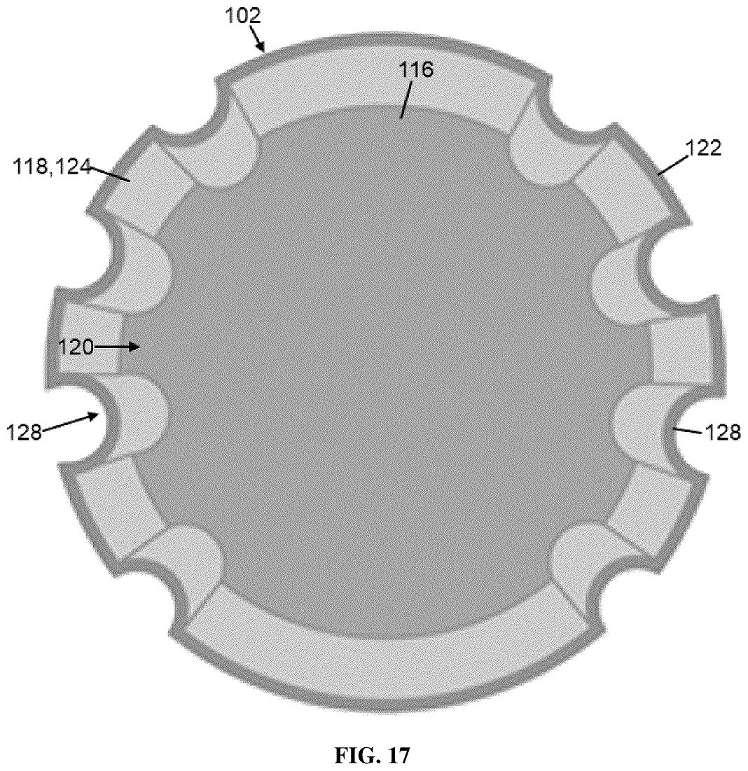

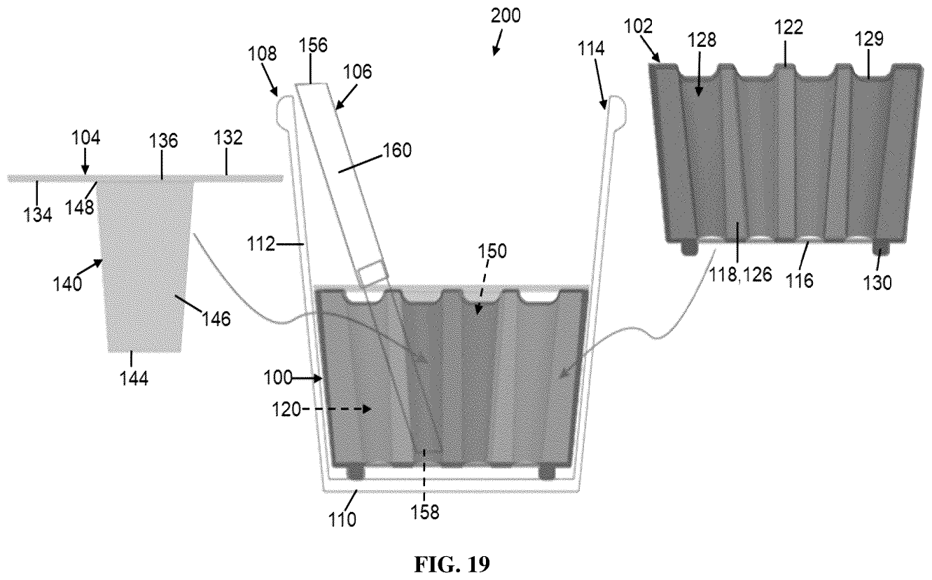

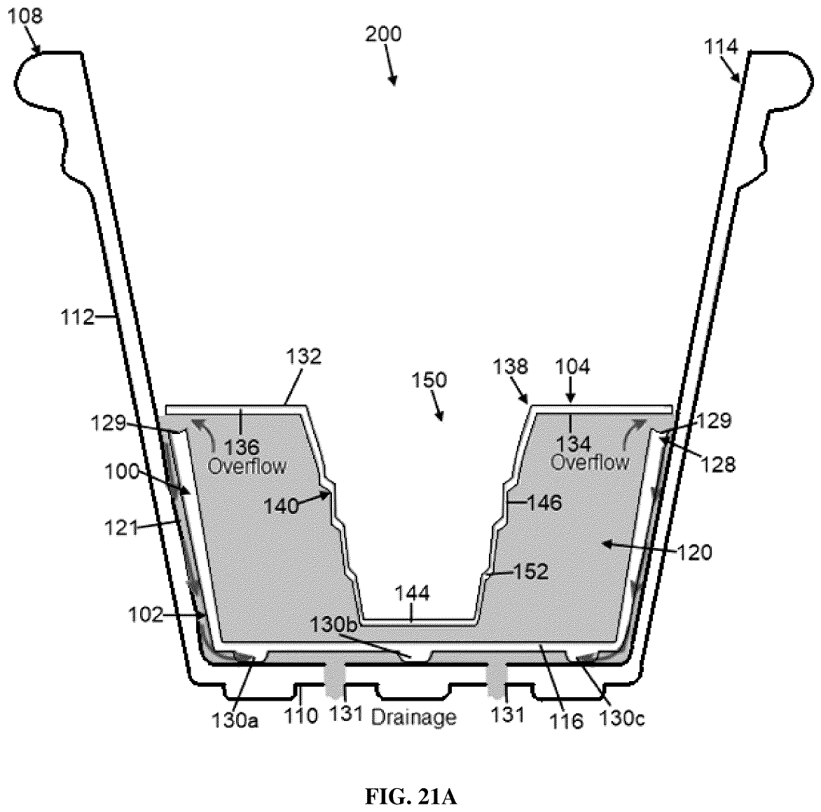

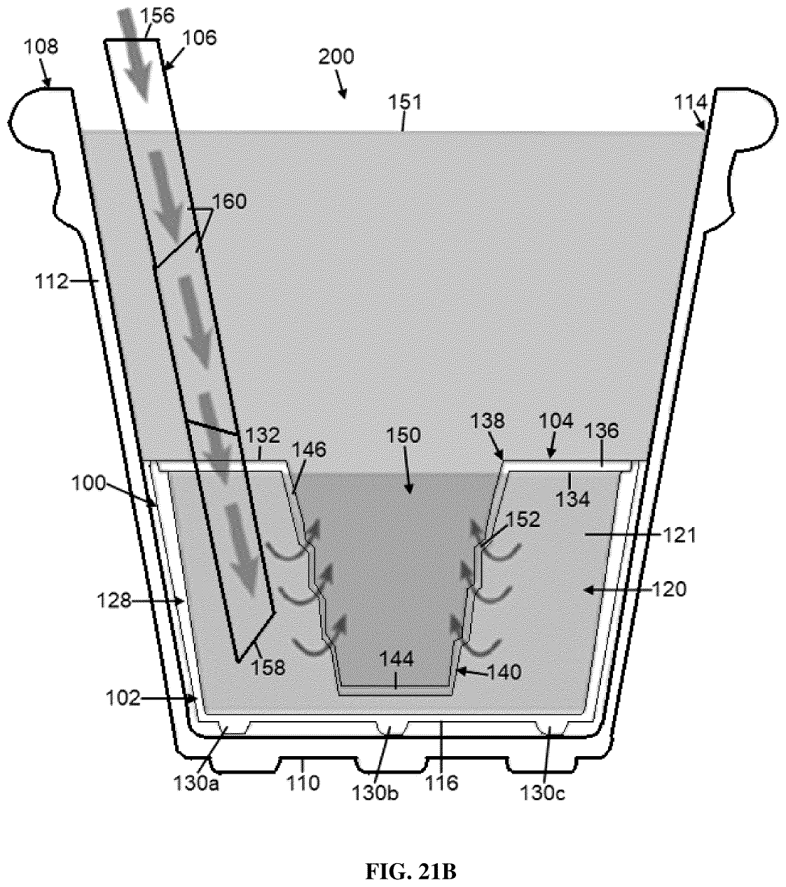

FIGS. 15-21B and 23-25 illustrate examples of the reservoir 102. The reservoir 102 is configured to be disposed in the container cavity 114 when the self-watering planter 200 is assembled, as shown in FIGS. 19-21B and 24-25. The reservoir 102 has a reservoir bottom wall 116 encircled or enclosed by a reservoir side wall 118. In some examples, the reservoir side wall 118 is tapered. However, the reservoir side wall 118 may be shaped differently to accommodate different container cavities 118 to facilitate nesting the reservoir 102 into the container cavity 114, which is advantageous for shipping and packaging purposes. The reservoir bottom wall 116 and the reservoir side wall 118 define a reservoir cavity 120 in the reservoir 102. The reservoir cavity 120 functions as a storage location for water 121 that is used to water plants which have been planted in the assembled self-watering planter 200, as illustrated in FIG. 21B. In addition, additives, supplements, and/or fertilizer may be included with the water 121 to facilitate plant growth.

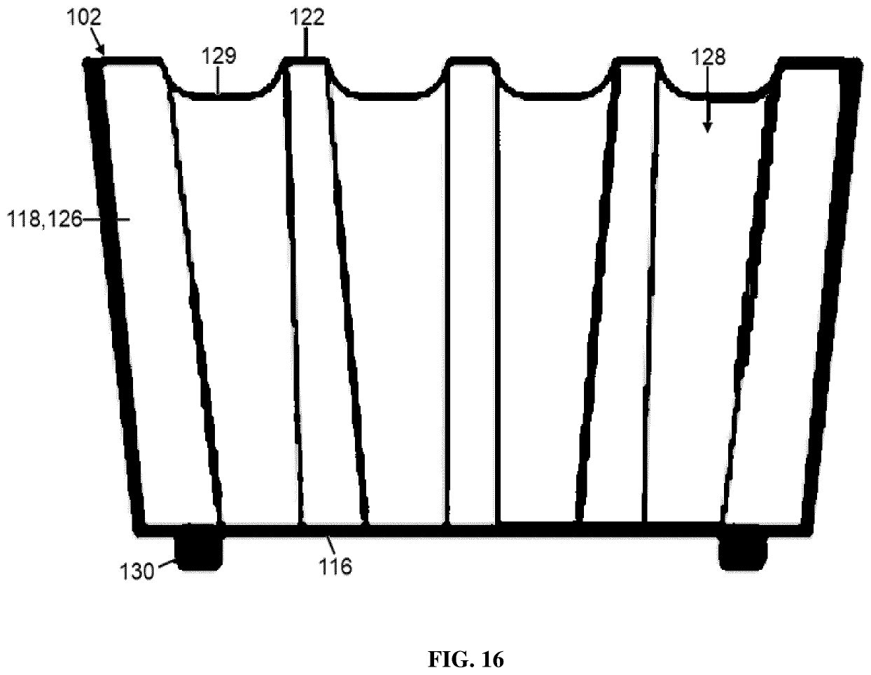

Referring to FIG. 18, the reservoir side wall 118 defines a reservoir top perimeter 122, a reservoir side wall inner surface 124, and a reservoir side wall outer surface 126. The reservoir top perimeter 122 is adapted to be covered by the platform 104 when the self-watering planter 200 is assembled. As illustrated in FIG. 16, the reservoir side wall outer surface 126 can define one or more gutters 128 formed along a length of the reservoir side wall 118. Each of the gutters 128 can be spaced apart around the reservoir side wall 118. Each of the gutters 128 may define a notch 129 on the reservoir top perimeter 122. The notch 129 interrupts the reservoir top perimeter 122, and functions as a gap between the reservoir side wall 118 and the platform 104 when the self-watering planter 200 is assembled. As illustrated in FIG. 21A, when the reservoir cavity 120 is overfilled with the water 121, the excess water 121 flows out from the reservoir cavity 120 and is led over the notches 129 and into the gutters 128, in a space between the gutters 182 and the container side wall 112, so as to drain down to the bottom of the container 108, into a space between the container bottom wall 110 and the reservoir 102 that is created by the feet 130a, 130b, 130c elevating the reservoir 102 off the container bottom wall 110. There, the water 121 may exit the container 108 through one or more drainage holes 131 in the container bottom wall 110. In addition, each of the gutters 128 can permit the reservoir side wall 118 room to flex and expand if the water in the reservoir cavity 120 freezes and thaws. Advantageously, this may prevent the reservoir side wall 118 and/or the container side wall 112 from cracking during the winter.

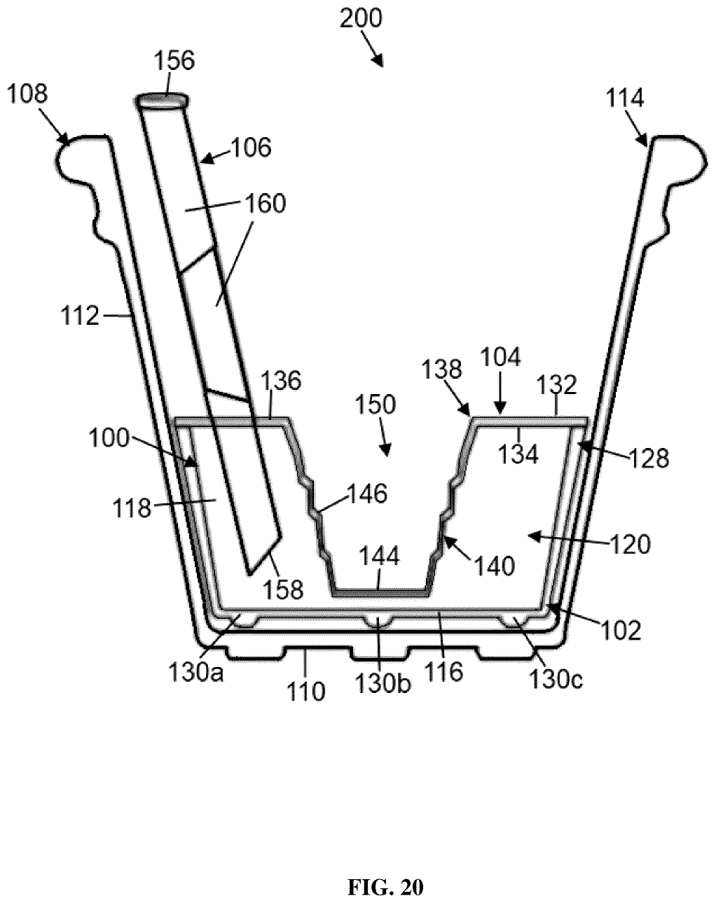

With reference to FIGS. 16, 19-21B, and 24-25, the reservoir 102 can further include a foot 130 disposed on an exterior surface of the reservoir bottom wall 116. The foot 130 permits the reservoir bottom wall 116 to be elevated from the container bottom wall 110. This can be particularly desirable for containers 108 that drain excess water using the one or more holes 131 formed in the container bottom wall 110. Thus, the foot 130 elevates the reservoir 102 to allow the excess water to be drained in such configurations. In certain examples, the reservoir 102 includes a plurality of feet 130 to provide enhanced stability. Each of the feet 130 is disposed on the exterior surface of the reservoir bottom wall 116. In certain examples, the plurality of feet 130 includes a first foot 130a, a second foot 130b, and/or a third foot 130c, as illustrated in FIGS. 20-21B, and 24-25. The second foot 130b can be disposed between the first foot 130a and the third foot 130c. This can facilitate greater stability for the reservoir 102.

As illustrated in FIGS. 15, 19-21B, 23, the platform 104 is adapted to be disposed over the reservoir cavity 120 when the self-watering planter 200 is assembled. The platform 104 may be circular to facilitate being disposed in the container 108 and covering the reservoir 102. However, the platform 104 may be shaped differently to accommodate different container cavities 118 and ensure the platform 104 covers the reservoir cavity 120 when the self-watering planter 200 is assembled. The platform 104 includes a platform top surface 132, a platform bottom surface 134, a platform main body 136, a platform aperture 138, a down tube 140, and a platform opening 142. The platform bottom surface 134 faces the reservoir cavity 120 when the self-watering planter 200 is assembled. The platform main body 136 is defined by the platform top surface 132 and the platform bottom surface 134. The platform main body 136 can have a diameter 135 corresponding to, or just smaller than, a diameter 137 of the container side wall 112 when the self-watering planter 200 is assembled. In addition, the platform main body 136 may engage with the container side wall 112 to stabilize the platform 104 when the self-watering planter 200 is assembled.

As illustrated in FIG. 15, the platform aperture 138 extends through the platform main body 136 from the platform top surface 132 to the platform bottom surface 134. The platform aperture 138 is defined by aperture walls 139 formed in the platform main body 136. As illustrated in FIG. 15, the platform aperture 138 may be circular. However, one skilled in the art can vary the shape and size of the platform aperture 138, as desired. The platform aperture 138 can be formed centrally on the platform 104. However, other locations for the platform aperture 138 on the platform 104 can also be chosen, within the scope of the present disclosure.

Referring now to FIGS. 18-21B and 23-25, the down tube 140 includes a down tube bottom wall 144 encircled or enclosed by a down tube side wall 146. The down tube side wall 146 includes a down tube top perimeter 148. The down tube top perimeter 148 is connected to the platform bottom surface 134. The down tube top perimeter 148 aligns and corresponds with the platform aperture 138. This forms a continuous hole through the platform 104 to the down tube bottom wall 144. In certain examples, the down tube 140 is formed integrally with the platform 104. In other examples, the down tube 140 may be selectively mated to the platform 104. For example, the down tube 140 may be threadedly connected to the platform aperture 138. Alternative methods of attaching the down tube 140 to the platform 104 can also be employed, such as adhesives, fasteners, snap fit mechanisms, magnets, and the like. In some examples, the down tube side wall 146 is tapered. However, the down tube side wall 146 may be shaped differently to accommodate different reservoir cavities.

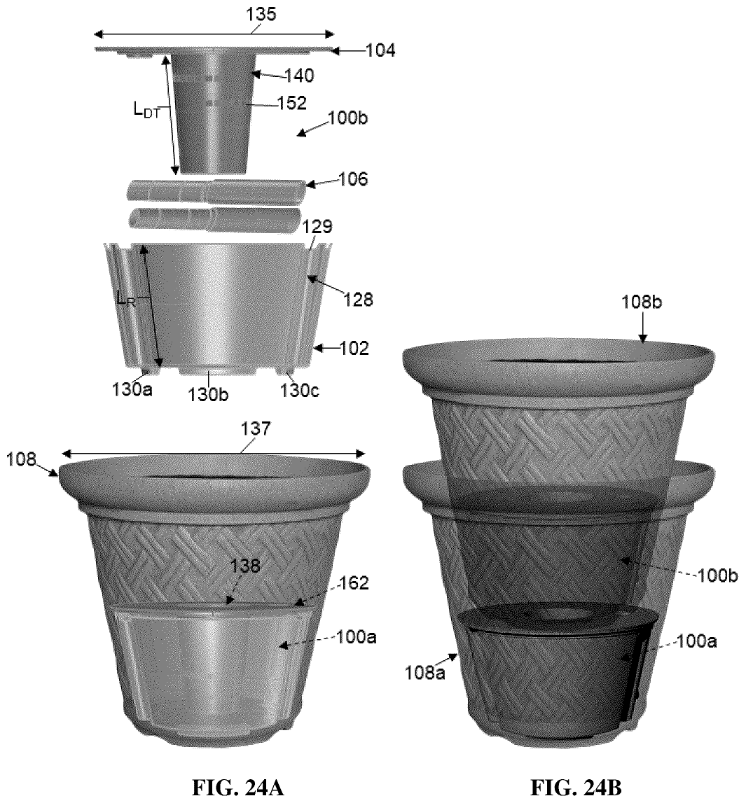

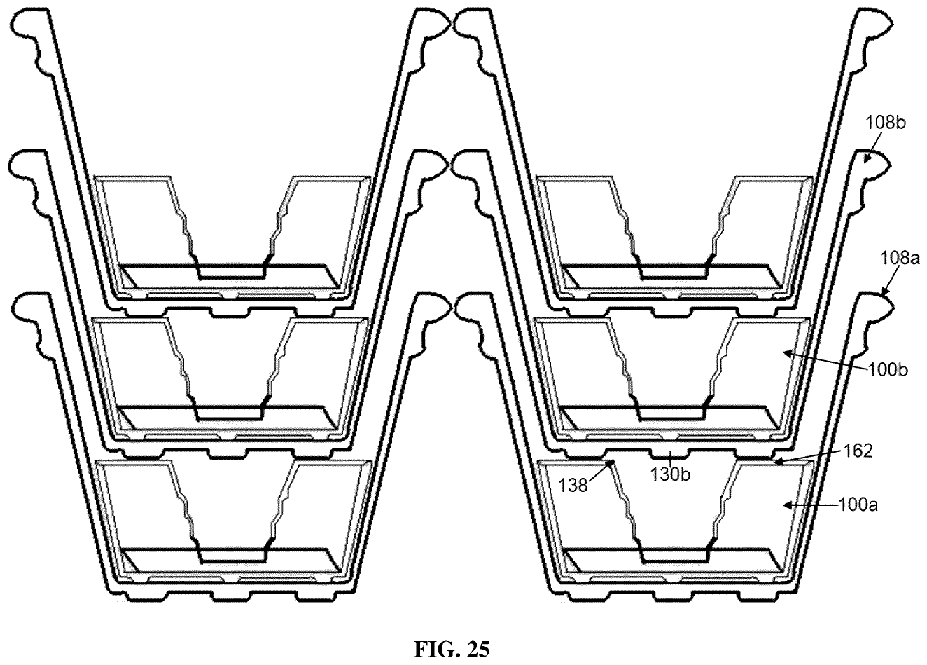

Referring to FIGS. 18, 24A, the down tube bottom wall 144 and the down tube side wall 146 define a down tube cavity 150 in the down tube 140. When the self-watering planter 200 is assembled, the down tube cavity 150 functions as a vessel for soil 151 and/or roots of the planted plant, as illustrated in FIG. 21B. The down tube side wall 146 has one or more slits 152 formed through the down tube side wall 146. The slits 152 may be spaced along the linear length of the down tube side wall 146 between the down tube top perimeter 148 and the down tube bottom wall 144. The slits 152 may be spaced in intervals, such as every one inch of linear length, but this is not necessary. The slits 152 may allow water 121 to seep into the down tube cavity 150 from the reservoir cavity 120. The water 121 that seeps into the down tube cavity 150 can be absorbed by the soil 151 that is packed into the down tube cavity 150 and distributed to the roots of the plant in the soil 151. Each of the slits 152 may be any shape or size of opening that permits the passage of a liquid, such as water 121, therethrough, but also prevents the soil 151 and/or the plant from passing from the down tube cavity 150 to the reservoir cavity 120.

As illustrated in FIGS. 20-21B and 24-25, when the platform 104 is disposed over the reservoir cavity 120, the down tube 140 is disposed within the reservoir cavity 120. In certain examples, the down tube 140 has a down tube length L_{DT} and the reservoir 102 has a reservoir length L_{R}. The down tube length L_{DT} can be substantially equal to the reservoir length L_{R}. Desirably, this allows the down tube 140 to be disposed in the reservoir cavity 120 while also allowing the platform 104 to remain substantially flush with the reservoir top perimeter 122. The down tube bottom wall 144 may also contact and engage the reservoir bottom wall 116, which can enhance the structural support for the platform 104.

As illustrated in FIG. 15, the platform opening 142 extends through the platform main body 136 from the platform top surface 132 to the platform bottom surface 134. The platform opening 142 is defined by opening walls 154 that arc part of the platform 104. As illustrated in FIG. 15, the platform opening 142 may be circular. However, a skilled artisan can vary the shape and size of the platform opening 142 as desired. As illustrated in FIG. 15, the platform opening 142 can be located off-center on the platform 104. Other locations for the platform opening 142 on the platform 104 can also be chosen, within the scope of the present disclosure.

With reference to FIGS. 19-20 and 21B, the fill tube 106 is adapted to be disposed through the platform opening 142 when the self-watering planter 200 is assembled. The fill tube 106 defines a fill tube first opening 156 and a fill tube second opening 158. The fill tube second opening 158 may be tapered or slanted so as to provide an angled exit for water into the reservoir cavity 120. When the fill tube 106 is disposed through the platform opening 142, the fill tube first opening 156 is positioned outside of the reservoir cavity 120, while the fill tube second opening 158 is positioned within the reservoir cavity 120. The fill tube first opening 156 is adapted to be put in fluid communication with a water source. The fill tube first opening 156 and the fill tube second opening 158 permit fluid communication between the water source and the reservoir cavity 120, as illustrated in FIG. 21B. Advantageously, this allows the reservoir cavity 120 to be filled with the water 121 without having to pass through the soil 151 and the plant. The fill tube 106 desirably allows the water 121 to be transported to the reservoir cavity 120, while also preventing the soil 151 from passing through the platform opening 142. However, it should be appreciated that the fill tube 106 is not required for the kit 100. Instead, a user can fill the reservoir cavity 120 by pouring water into the platform opening 142.

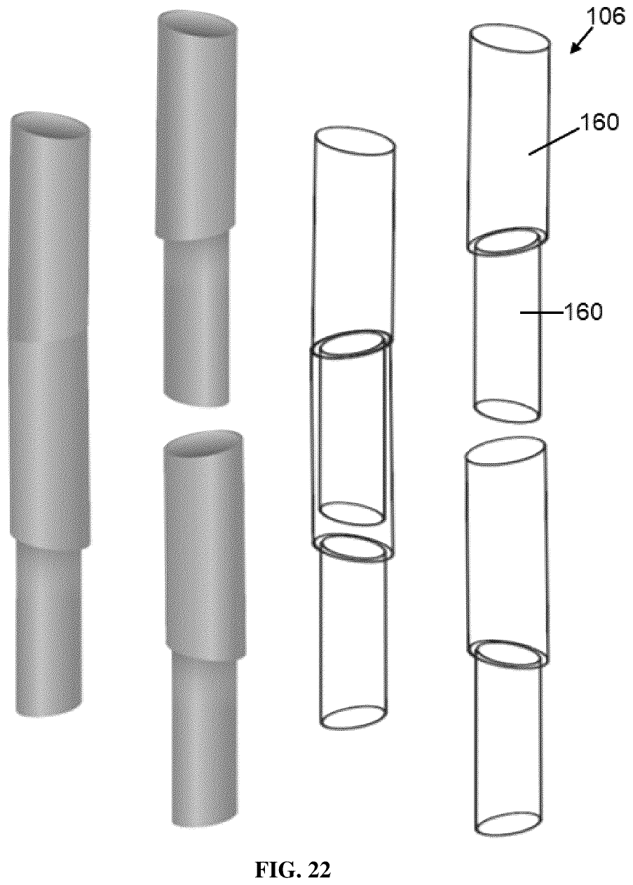

As illustrated in FIGS. 19-20 and 21B-24, the fill tube 106 may include a plurality of segments 160. Each of the segments 160 can be assembled together to form the fill tube 106. This may be accomplished using a variety of methods, such as telescopically connecting each of the segments 160 to one of the other segments 160. Advantageously, this allows the fill tube 106 to be disassembled into segments 160 that can be conveniently stored and reassembled into the fill tube 106 when desired. Additional segments 160 may also be employed to lengthen the fill tube 106 in order to accommodate deeper containers 108.

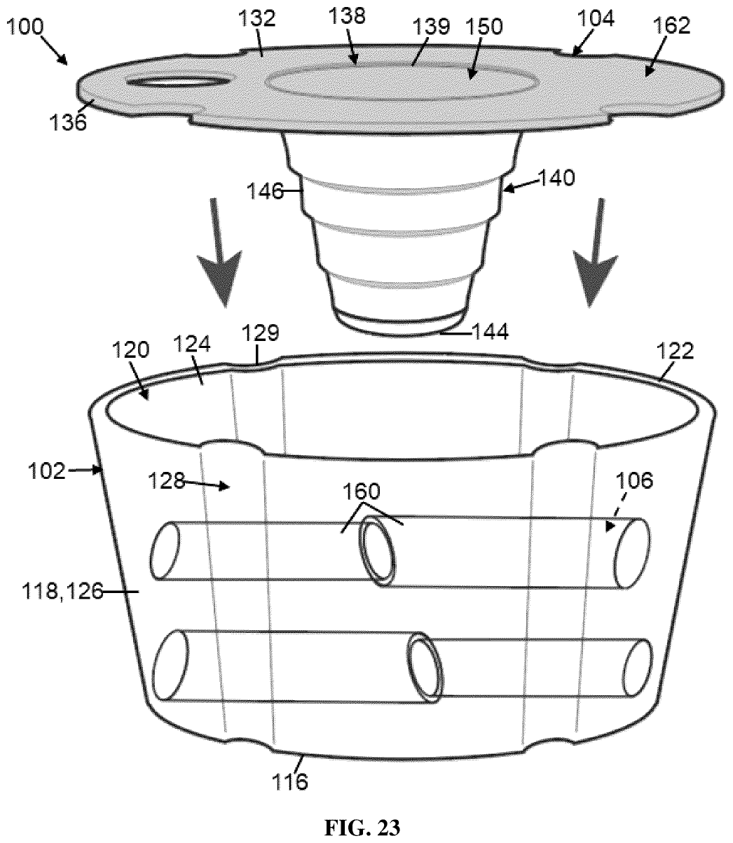

With reference to FIG. 23, the kit 100 can be housed in a stored configuration. In the stored configuration, the fill tube 106, if present, is at least partially disassembled into segments 160 and disposed in the reservoir 102. The platform 104 is disposed over the reservoir cavity 120 with the down tube 140 disposed in the reservoir cavity 120 adjacent to the segments 160 of the fill tube 106 (if the fill tube 106 is present). A method of moving the kit 100 to the stored configuration may include at least partially disassembling the fill tube 106 into segments 160; disposing the segments 160 into the reservoir cavity 120; and disposing the platform 104 over the reservoir cavity 120. Desirably, in the stored configuration, the platform top surface 132 has a flat stacking surface 162 which can be used to support other miscellaneous items and/or additional kits 100. In certain examples, stacking subsequent kits 100 on top of each other in the stored configuration can be further facilitated by having the shape and size of the second foot 130b correspond to the platform aperture 138. Thus, the second foot 130b of one kit 100 can be received by the platform aperture 138 of another kit 100 to lock the two kits in a stacking position, as illustrated in FIG. 25. These stacked kits 100 can be stored in the container cavity 114 of a container 108 for even more convenient storage. Referring to FIG. 25, a first kit 100a in the stored configuration can be disposed in the container cavity 114 of a first container 108a while a second container 108b having a second kit 100b stored therein is stacked on top of the flat stacking surface 162 of the first kit 100a. Advantageously, this can enable convenient storage for a plurality of kits 100 and containers 108 for end users and retailers.

Referring now to FIGS. 18-21B, the self-watering planter 200 can include the container 108, the reservoir 102, the platform 104, and, optionally, the fill tube 106. The container 108 can be made of a variety of materials, including but not limited to stoneware glazed ceramics. The container 108 can be any suitable size and shape. The reservoir 102 is disposed in the container cavity 114. The platform 104 is disposed over the reservoir cavity 120 with the down tube 140 disposed in the reservoir cavity 120. The fill tube 106 is disposed through the platform opening 142. Advantageously, the reservoir 102, the platform 104, and the fill tube 106 can be removed from the container 108 for easier storage. Also, in the event that a user replaces the container 108 or the container 108 becomes damaged, the reservoir 102, the platform 104, and/or the fill tube 106 can be removed from the container 108 and used with a new container 108.

A method of assembling the self-watering planter 200 can include disposing the reservoir 102 in the container cavity 114; disposing the platform 104 over the reservoir cavity 120; and, optionally, disposing the fill tube 106 through the platform opening 142. In the examples where the fill tube 106 includes segments 160, the method can also include a step of assembling the fill tube 106 from the plurality of segments 160 prior to disposing the fill tube 106 through the platform opening 142.

A method of watering a plant can include disposing the reservoir 102 in the container cavity 114; disposing the platform 104 over the reservoir cavity 120; disposing the fill tube 106 through the platform opening 142; disposing soil 151 in the down tube cavity 150; planting a plant in the soil 151; and adding water 121 to the cavity via the fill tube 106. In the examples where the fill tube 106 includes segments 160, the method can also include a step of assembling the fill tube 106 from the plurality of segments 160 prior to disposing the fill tube 106 through the platform opening 142. Optionally, the steps of disposing the fill tube 106 through the platform opening 142 and adding the water 121 can be replaced by a step of adding the water 121 to the cavity via the platform opening 142.

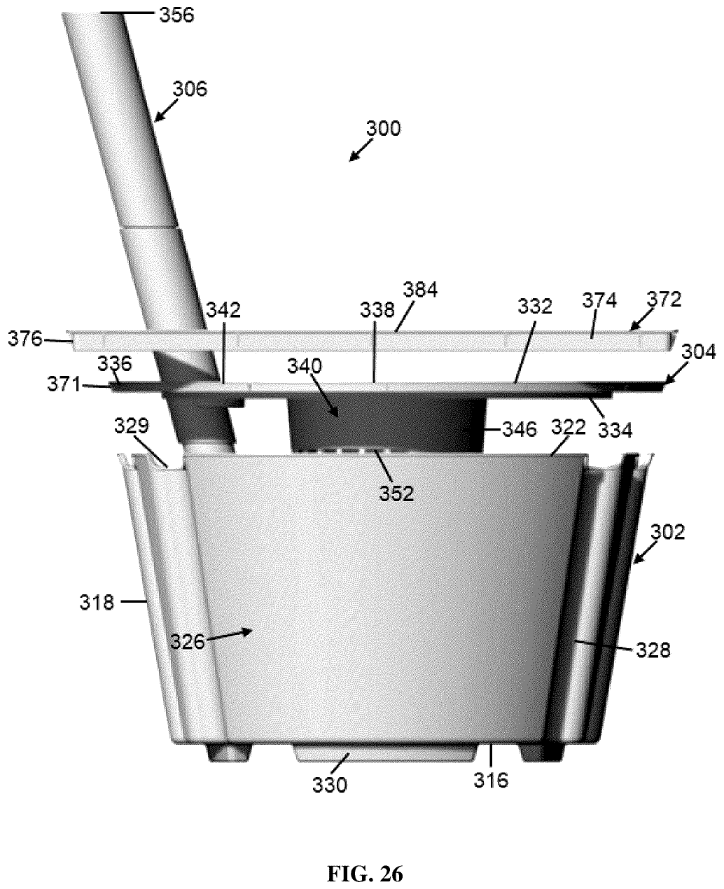

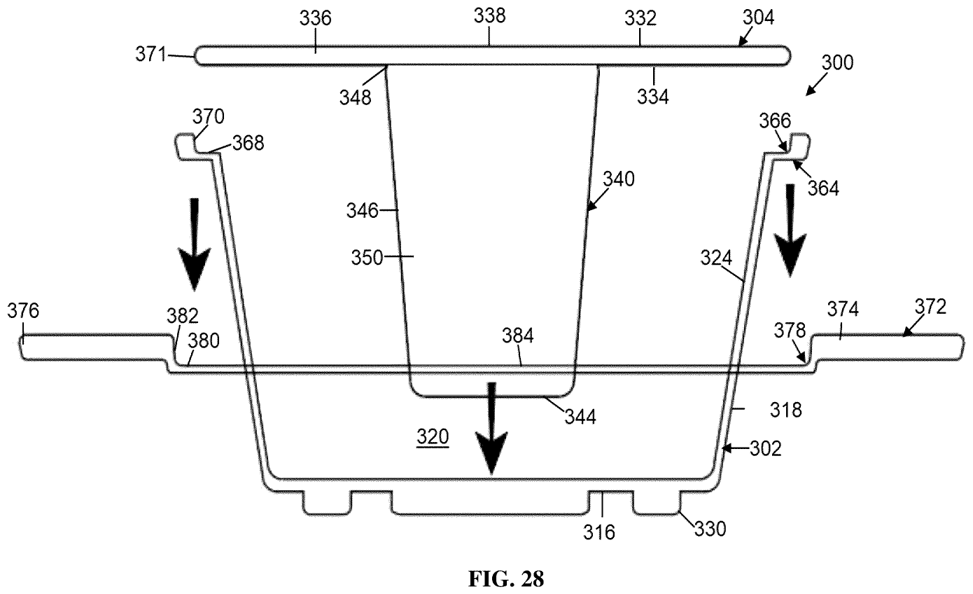

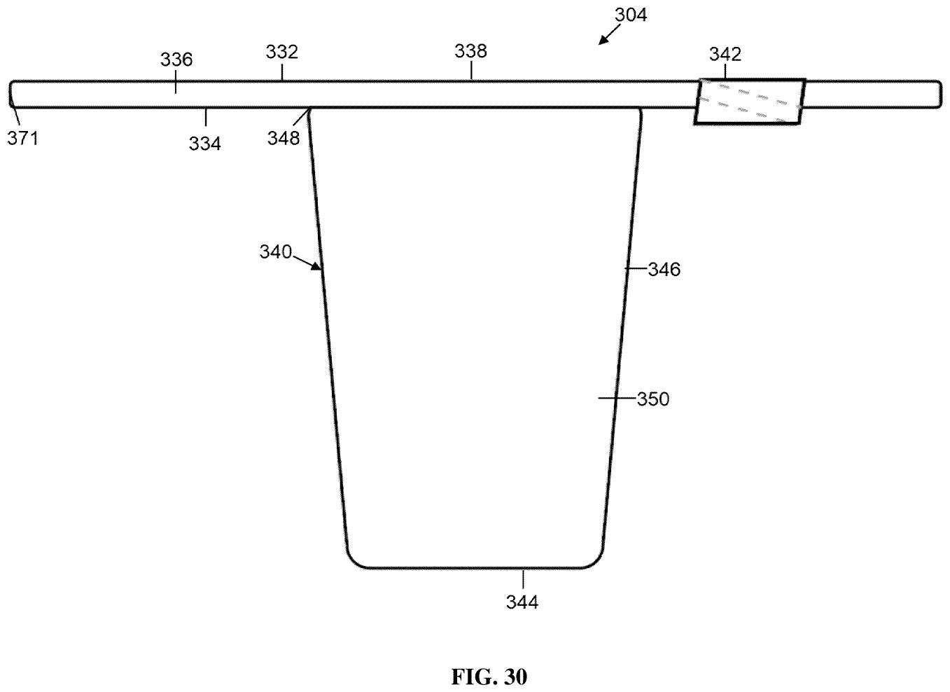

With reference to FIGS. 26-32, another embodiment of a self-watering planter kit 300 is illustrated. The kit 300 is similar to the kit 100, except as described below. Thus, the kit 300 may include a reservoir 302, a platform 304, and a fill tube 306, as illustrated in FIG. 26. The reservoir 302 has a reservoir bottom wall 316 encircled or enclosed by a reservoir side wall 318. The reservoir bottom wall 316 and the reservoir side wall 318 define a reservoir cavity 320 in the reservoir 302. The reservoir side wall 318 defines a reservoir top perimeter 322, a reservoir side wall inner surface 324, and a reservoir side wall outer surface 326. The reservoir side wall outer surface 326 can define one or more gutters 328 formed along a length of the reservoir side wall 318. Each of the gutters 328 can be spaced apart around the reservoir side wall 318. Each of the gutters 328 may define a notch 329 on the reservoir top perimeter 322. The notch 329 interrupts the reservoir top perimeter 322. The reservoir 302 can further include a foot 330 disposed on an exterior surface of the reservoir bottom wall 316. The platform 304 includes a platform top surface 332, a platform bottom surface 334, a platform main body 336, a platform aperture 338, a down tube 340, and a platform opening 342. The down tube 340 includes a down tube bottom wall 344 encircled or enclosed by a down tube side wall 346. The down tube side wall 346 includes a down tube top perimeter 348. The down tube top perimeter 348 is connected to the platform bottom surface 334. The down tube bottom wall 344 and the down tube side wall 346 define a down tube cavity 350 in the down tube 340. The down tube side wall 346 has one or more slits 352 formed therethrough. The fill tube 306 defines a fill tube first opening 356 and a fill tube second opening 358. The self-watering planter kit 300 can be combined with a container, like the containers discussed hereinabove, to form a self-watering planter.

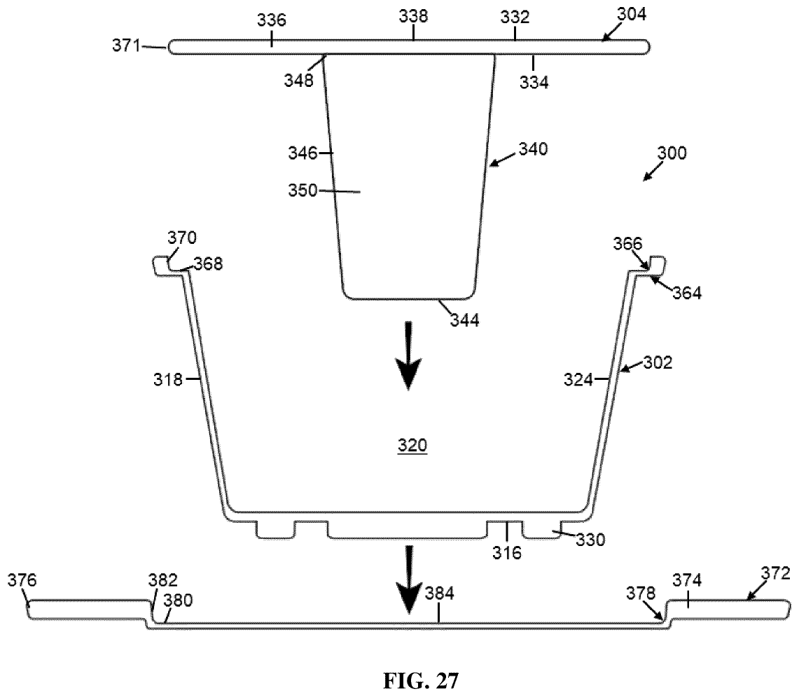

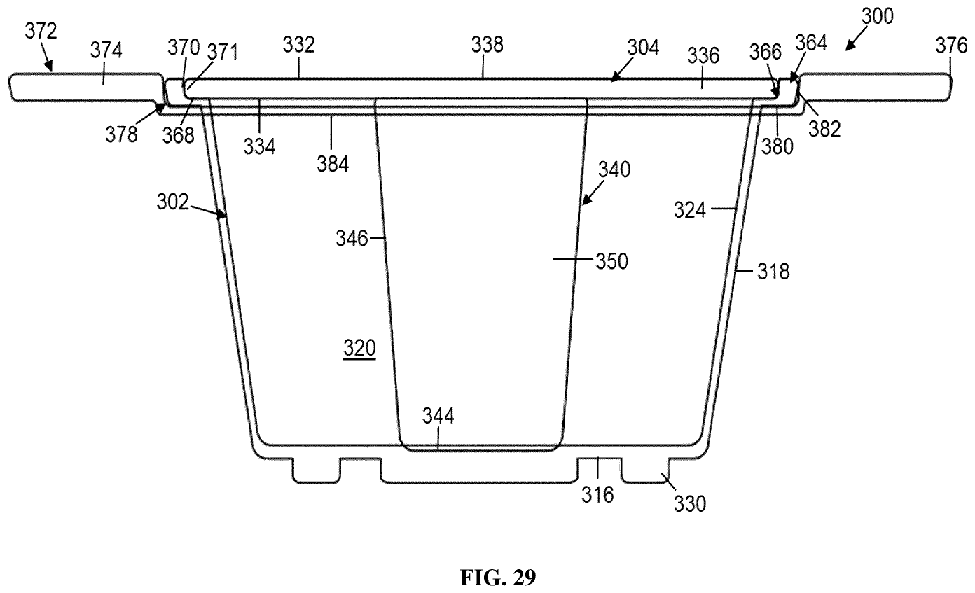

Referring still to FIGS. 26-32, in this embodiment, the reservoir top perimeter 322 includes a reservoir outer lip 364 extending from the reservoir top perimeter 322 and enclosing the reservoir top perimeter 322, as illustrated in FIGS. 27-29. The reservoir outer lip 364 defines a reservoir depression 366. The reservoir depression 366 is adapted to receive the platform main body 336 when the platform 304 is disposed on the reservoir 302. FIG. 29 illustrates the reservoir depression 366 receiving the platform main body 336. The reservoir depression 366 can be shaped to correspond with the platform main body 336. For example, the reservoir depression 366 can be circular. In certain embodiments, the reservoir depression 366 is rectangular. It should be appreciated that other shapes can be selected to facilitate the reservoir depression 366 receiving the platform main body 336.

Referring to FIGS. 27-29, the reservoir depression 366 has a reservoir depression bottom wall 368 and a reservoir depression side wall 370. The reservoir depression bottom wall 368 can be substantially perpendicular to the reservoir depression side wall 370. However, this is not strictly necessary, and other angles or relative positioning of the reservoir depression bottom wall 368 and reservoir depression side wall 370 are possible and encompassed within the scope of the present disclosure. The reservoir depression bottom wall 368 is adapted to receive and support an outer edge 371 of the platform bottom surface 334 when the platform 304 is disposed in the reservoir depression 366 and the down tube is disposed in the reservoir cavity 320, as illustrated in FIG. 29. The outer edge 371 of the platform bottom surface 334 can fit tightly in the reservoir depression 366 and be supported by the reservoir depression bottom wall 368 and abut the reservoir depression side wall 370. Desirably, this facilitates retaining the platform 304 in the reservoir depression 366. In certain embodiments, the outer edge 371 of the platform 304 is rounded to facilitate fitting the outer edge 371 of the platform 304 tightly in the reservoir depression 366. The reservoir depression bottom wall 368 also provides additional structural support for the platform 304 when the platform 304 is disposed in the reservoir depression 366.

Referring again to FIGS. 26-29, the self-watering planter kit 300 can also include a skirt adaptor 372. The skirt adaptor 372 is configured to be disposed in the container when the kit 300 is assembled. The skirt adaptor 372 has a skirt main body 374. The skirt main body 374 defines a skirt outer edge 376 and a skirt depression 378. The skirt outer edge 376 is adapted to tightly abut the container side wall when the skirt adaptor 372 is disposed in the container. Advantageously, this facilitates retaining the skirt adaptor 372 in the container. In certain embodiments, the skirt outer edge 376 is rounded to facilitate fitting the skirt outer edge 376 tightly in the container. The skirt main body 374 can be shaped to correspond to the container. For example, the skirt main body 374 may be circular. In certain embodiments, the skirt main body 374 is square. A skilled artisan can employ different shapes to correspond to different containers, within the scope of the present disclosure.

The skirt depression 378 is adapted to receive the reservoir 302 when the kit 300 is assembled, as illustrated in FIG. 29. The skirt depression 378 defines a skirt depression bottom wall 380 and a skirt depression side wall 382. The skirt depression bottom wall 380 can be substantially perpendicular to the skirt depression side wall 382. However, other angles and relative positioning of the skirt depression side wall 382 and skirt depression bottom wall 380 are possible and encompassed within the scope of the present disclosure. The skirt depression bottom wall 380 defines a skirt opening 384. The reservoir 302 is adapted to be disposed through the skirt opening 384 when the kit 300 is assembled, as illustrated in FIGS. 27-29. The skirt depression bottom wall 380 is adapted to receive and support the reservoir outer lip 364 when the reservoir 302 is disposed through skirt opening 384. The reservoir outer lip 364 can fit tightly in the skirt depression 378 and be supported by the skirt depression bottom wall 380 and abut the skirt depression side wall 382, as shown in FIG. 29. Desirably, this facilitates retaining the reservoir 302 in the skirt depression 378. The skirt depression bottom wall 380 also provides additional structural support to the reservoir 302 when the reservoir 302 is disposed in the skirt depression 378 and skirt opening 384.

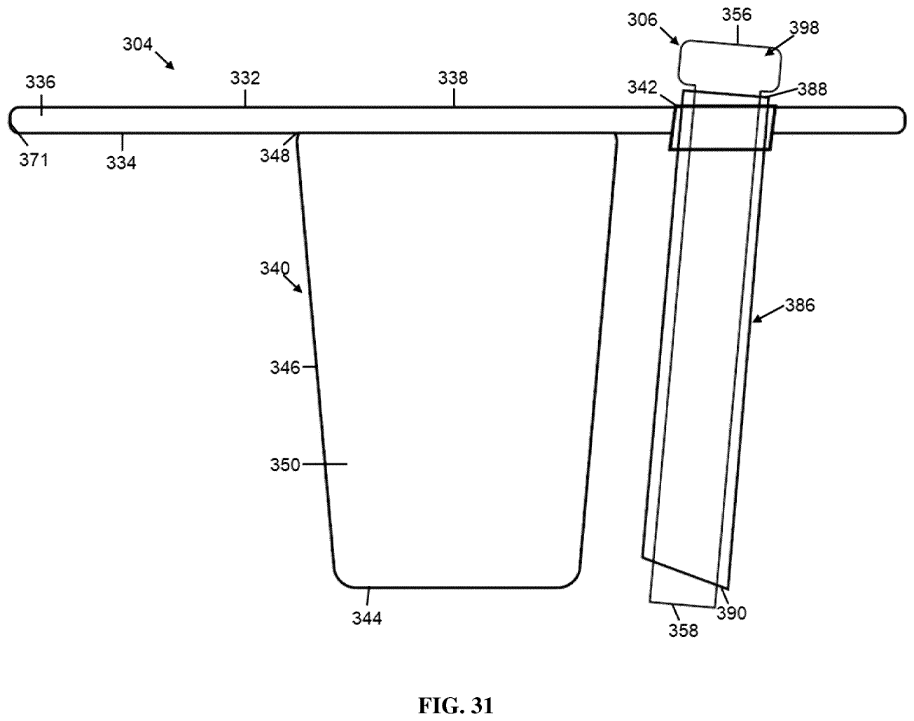

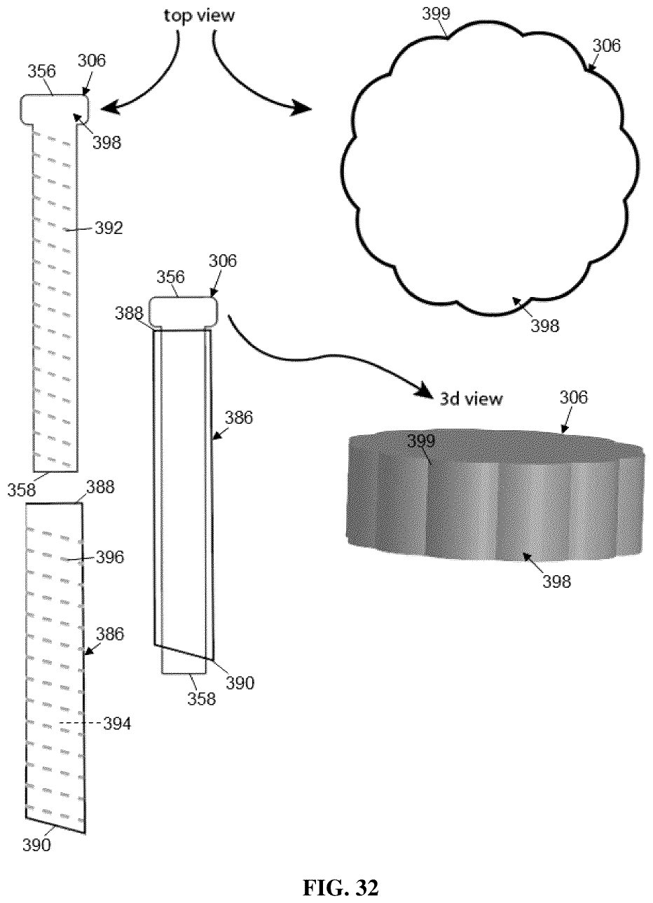

Referring now to FIG. 31 and FIG. 32, the fill tube 306 can include a fill tube sheath 386. The fill tube sheath 386 defines a fill tube sheath first opening 388 and a fill tube sheath second opening 390. The fill tube 306 is adapted to be disposed in the fill tube sheath first opening 388 and through the fill tube sheath 386, as illustrated in FIGS. 31-32. In certain embodiments, the fill tube 306 defines a fill tube threaded outer surface 392 and the fill tube sheath 386 defines a fill tube sheath threaded inner surface 394, as illustrated in FIG. 32. The fill tube threaded outer surface 392 is configured to correspond and be threadedly received by the fill tube sheath threaded inner surface 394. The threads of the fill tube threaded outer surface 392 and the fill tube sheath threaded inner surface 394 can be large and wide. This permits the fill tube 306 to be easily adjusted axially by screwing the fill tube 306 along the fill tube sheath threaded inner surface 394. The fill tube sheath 386 is configured to be disposed through the platform opening 342 when the kit 300 is assembled. In certain embodiments, the fill tube sheath 386 defines a fill tube sheath threaded outer surface 396, and the platform opening 342 is a platform threaded opening 342, as shown in FIG. 32. The fill tube sheath threaded outer surface 396 is configured to correspond to and be threadedly received by the platform threaded opening 342, as shown in FIG. 32. The threads of the fill tube sheath threaded outer surface 396 and the platform threaded opening 342 can be large and wide. This permits the fill tube sheath 386 to be adjusted axially by screwing the fill tube sheath 386 along the platform threaded opening 342. Thus, the user can adjust a total length of the fill tube 306 by axially adjusting the fill tube sheath 386 within the platform threaded opening 342 and axially adjusting the fill tube 306 within the fill tube sheath first opening 388. Desirably, this allows the fill tube 306 to accommodate a variety of different sized containers.

Referring still to FIGS. 31-32, in certain examples, the fill tube 306 has a screw cap 398. The screw cap 398 is configured to facilitate gripping the fill tube 306 to screw the fill tube 306 into the fill tube sheath 386 by hand. The outer perimeter of the screw cap 398 can include screw cap grooves 399 to allow a user's fingers to easily grip the screw cap 398.

In certain embodiments, any or a majority of corners defined by each of the reservoir 302, platform 304, down tube, and the skirt adaptor 372 can be rounded, as illustrated in FIG. 27-29. In a non-limiting example, the feet of reservoir 302 are rounded. Rounded the corners are desirable for allowing each of the components of the kit 300 to be disposed in the container and be tightly fitted in the container. However, it should be appreciated that one skilled in the art can adjust the corners of each of the components of the kit 300, as desired.

A method of assembling the self-watering planter 300 can include disposing the skirt adaptor 372 into the container cavity; disposing the reservoir 302 into the skirt opening 384; disposing the platform 304 in the reservoir depression 366. In certain embodiments, the method further includes threadedly disposing the fill tube sheath 386 through the platform opening 342; and threadedly disposing the fill tube 306 through the fill tube sheath first opening 388.

Referring to FIGS. 26-31, a method of watering a plant can include positioning the skirt adaptor 372 in the container cavity; positioning the reservoir 302 in the skirt opening 384; positioning the platform 304 in the reservoir depression 366; threadedly connecting the fill tube sheath 386 within the platform opening 342; threadedly connecting the fill tube 306 within the fill tube sheath first opening 388; positioning soil in the down tube cavity 350; planting a plant in the soil; and adding water to the reservoir cavity 320 via the fill tube 306. Optionally, the steps of connecting and positioning the fill tube 306 and the fill tube sheath 386, and adding the water, can be replaced by a step of adding the water to the cavity via the platform opening 342.

Advantageously, the self-watering planter kits 100, 300 allow for a variety of containers to be converted into the self-watering planters. Also, when the reservoir cavity 120 is overfilled with the water 121, the excess water passes through the notch 129 of one or more of the gutters 128, and out of the reservoir cavity 120. In addition, the one or more feet 130 permit the reservoir bottom wall 116 to be elevated from the container bottom wall 110, which can be particularly desirable for containers 108 that drain excess water using the one or more holes 131 formed on the container bottom wall 110, and can prevent cracking from freeze/thaw cycles.

The principle and mode of operation of this disclosure have been explained and illustrated in its various embodiments. However, it must be understood that this disclosure may be practiced otherwise than as specifically explained and illustrated without departing from its spirit or scope.

1. A self-watering planter kit comprising:
a reservoir having a reservoir bottom wall encircled or enclosed by a reservoir side wall, the reservoir defining a reservoir cavity bounded by the reservoir bottom wall and the reservoir side wall, wherein the reservoir further comprises an outer surface defining a gutter;
a platform configured to cover the reservoir cavity, the platform having a platform top surface, a platform bottom surface, a platform aperture extending through the platform, and a platform opening extending through the platform; and
a down tube comprising a down tube bottom wall encircled by a down tube side wall and defining a down tube cavity aligned with the platform aperture, wherein the down tube comprises a slit formed through the down tube side wall.

2. The self-watering planter kit of claim 1, wherein the gutter defines a notch that interrupts a top perimeter of the reservoir.

3. The self-watering planter kit of claim 1, further comprising a fill tube configured to be disposed through the platform opening.

4. The self-watering planter kit of claim 3, wherein the fill tube comprises a plurality of telescopically connected segments.

5. The self-watering planter kit of claim 1, wherein the self-watering planter kit comprises a plurality of gutters, each of the plurality of gutters defining a notch that interrupts a top perimeter of the reservoir.

6. The self-watering planter kit of claim 1, wherein the down tube comprises a plurality of slits formed through the down tube side wall.

7. The self-watering planter kit of claim 1, wherein the reservoir comprises a foot disposed on an exterior surface of the reservoir bottom wall.

8. The self-watering planter kit of claim 1, wherein the reservoir comprises a plurality of feet disposed on an exterior surface of the reservoir bottom wall.

9. The self-watering planter kit of claim 1, wherein the down tube has a down tube length and the reservoir has a reservoir length, and the down tube length corresponds to the reservoir length.

10. The self-watering planter kit of claim 1, wherein the reservoir side wall is tapered.

11. The self-watering planter kit of claim 1, wherein the down tube side wall is tapered.

12. A self-watering planter kit comprising:
a reservoir having a reservoir bottom wall encircled or enclosed by a reservoir side wall, the reservoir defining a reservoir cavity bounded by the reservoir bottom wall and the reservoir side wall, wherein the reservoir further comprises a foot disposed on an exterior surface of the reservoir bottom wall;
a platform configured to cover the reservoir cavity, the platform having a platform top surface, a platform bottom surface, a platform aperture extending through the platform, and a platform opening extending through the platform; and
a down tube comprising a down tube bottom wall encircled by a down tube side wall and defining a down tube cavity aligned with the platform aperture, wherein the down tube comprises a slit formed through the down tube side wall.

13. The self-watering planter kit of claim 12, further comprising a gutter defining a notch that interrupts a top perimeter of the reservoir.

14. The self-watering planter kit of claim 13, further comprising a plurality of gutters each defining a notch that interrupts a top perimeter of the reservoir.

15. The self-watering planter kit of claim 12, further comprising a fill tube configured to be disposed through the platform opening.

16. The self-watering planter kit of claim 15, wherein the fill tube comprises a plurality of telescopically connected segments.

17. The self-watering planter kit of claim 12, wherein the down tube comprises a plurality of slits formed through the down tube side wall.

18. The self-watering planter kit of claim 12, comprising a plurality of feet disposed on the exterior surface of the reservoir bottom wall.

19. The self-watering planter kit of claim 12, wherein the down tube has a down tube length and the reservoir has a reservoir length, and the down tube length corresponds to the reservoir length.

20-21. (canceled)

22. A method of assembling a self-watering planter, the method comprising:
placing a reservoir in a cavity of a container, the reservoir having a reservoir bottom wall encircled or enclosed by a reservoir side wall, the reservoir defining a reservoir cavity bounded by the reservoir bottom wall and the reservoir side wall, wherein the reservoir further comprises an outer surface defining a gutter; and
disposing a platform over the reservoir cavity, the platform having a platform top surface, a platform bottom surface, a platform aperture extending through the platform, a platform opening extending through the platform, and a down tube comprising a down tube bottom wall encircled by a down tube side wall and defining a down tube cavity aligned with the platform aperture, wherein the down tube comprises a slit formed through the down tube side wall.

23-57. (canceled)
